(19) United States
(12) Patent Application Publication
(10) Pub. No.: US 2026/0353220 A1
(43) Pub. Date: Nov. 5, 2026

(54) METHOD AND SYSTEM FOR MANAGING LOW-LATENCY COMMUNICATION IN A COMMUNICATION NETWORK

(71) Applicant: SAMSUNG ELECTRONICS CO., LTD., Suwon-si (KR)

(72) Inventors: Manasi EKKUNDI, Bangalore (IN); Rishabh ROY, Bangalore (IN); Karthik Srinivasa GOPALAN, Bangalore (IN)

(21) Appl. No.: 19/662,251

(22) Filed: Apr. 29, 2026

Related U.S. Application Data
(63) Continuation of application No. PCT/KR2026/096231, filed on Apr. 23, 2026.

(30) Foreign Application Priority Data
May 5, 2025 (IN) 202541043624
Apr. 7, 2026 (IN) 202541043624

(51) Int. Cl. H04W 36/08; H04W 36/00; H04W 36/30

(52) U.S. Cl. CPC H04W 36/08; H04W 36/0016; H04W 36/008357; H04W 36/30

(57) ABSTRACT

The present disclosure relates to a method and system for managing low-latency communication in a communication network. The method may include selecting a target AP from one or more candidate APs during a preparation phase of a roaming procedure; transmitting a first reconfiguration request message to an Access Point (AP), during an execution phase of the roaming procedure; receiving a first reconfiguration response message from the AP, based on the transmitted first reconfiguration request message, wherein the first reconfiguration response message comprises at least a Down Link (DL) drain time of the selected target AP; and managing the low-latency communication in the communication network, based on the received first reconfiguration response message.

### CROSS-REFERENCE TO RELATED APPLICATIONS

This application is a continuation of International Application No. PCT/KR2026/096231 designating the United States, filed on Apr. 23, 2026, in the Korean Ministry of Intellectual Property Receiving Office and claiming priority to Indian Provisional Patent Application No. 202541043624, filed on May 5, 2025, and Indian Complete patent application No. 202541043624, filed on Apr. 7, 2026, in the Indian Patent Office, the disclosures of each of which are incorporated by reference herein in their entireties.

### BACKGROUND

### Field

The disclosure generally relates to network management, for example, but not exclusively, to a method and system for managing low-latency communication in a communication network.

### Description of Related Art

Low Latency applications are gaining traction in the user ecosystem with development of Extended Reality (XR), gaming (cloud and real-time), industry automation etc. Existing systems have developed features to support high reliability for such low latency applications and use cases. Such applications require low latency and high reliability to provide a seamless user experience. One existing system is developing a multitude of features to facilitate high reliability and low latency. These features include Low Latency Indication (LLI) support from non-Access Point Station (non-AP STA) to Access Point (AP), Seamless Roaming transition, Co-ordinated-Time Domain Multiple Access (Co-TDMA) operation (and other Multi-AP features), peer-to-peer enhancements and so on.

A Low Latency Indication (LLI) support supports the indication of low latency needs from non-AP STA to AP so that the AP schedules the non-AP STA that has better low latency needs and reduce the loss of packets due to packet timer expiry. The current proposal includes low latency indication support only between a non-AP STA and AP. But the existing systems do not consider scenarios such as how a non-AP Multi-Link Device (MLD) indicate low latency needs during seamless transition or how a non-AP MLD ensures low latency traffic prioritization during M-AP co-ordination techniques.

For example, the current proposal is limited to Low Latency Indication support from a non-AP STA to an AP. But the current proposal does not consider various scenarios where low latency indication support is going to be useful. That is, during seamless roaming, the current proposal does not focus on what is the procedure during Roaming Preparation and Execution phase, which contents need to be exchanged, where and how the message related to LLI needs to be indicated. Similarly, in procedures such as Co-TDMA during phases such as discovery and negotiation or polling and Transmission opportunity (TXOP) allocation phase, the current procedures do not define mechanisms and do not provide framework to indicate LLI.

In view of the above, there is a need to address above-mentioned one or more problems.

The information disclosed in this background of the disclosure section is simply to aid in understanding and should not be taken as an acknowledgement or any form of suggestion that this information forms the prior art already known to a person skilled in the art.

### SUMMARY

According to an example embodiment, the present disclosure provides a method of managing low-latency communication in a communication network. The method comprises: selecting, by a non-Access Point station (non-AP STA), a target Access Point (AP) from one or more candidate APs during a roaming procedure; transmitting, by the non-AP STA, a first reconfiguration request message to the AP, during the roaming procedure, wherein the first reconfiguration request message comprises at least one of a roaming phase type, an Identifier (ID) of the selected target AP indicating Media Access Control (MAC) address, and Quality of Service (QoS) characteristics of the non-AP STA comprising at least one of number of queued low latency packets, expiration time of the low latency packets, and Quality Of Service (QoS) requirements of the low latency packets, wherein the AP comprises one of a source AP or the selected target AP; receiving, by the non-AP STA, a first reconfiguration response message from the AP, based on the transmitted first reconfiguration request message, wherein the first reconfiguration response message comprises at least a Down Link (DL) drain time of the selected target AP, wherein the DL drain time is set based on QoS requirements indicated in the first reconfiguration request message; and managing, by the non-AP STA, the low-latency communication in the communication network, based on the received first reconfiguration response message.

According to various example embodiments, a non-Access Point station (non-AP STA) for managing low-latency communication in a communication network is provided. The non-AP STA comprises: at least one processor, comprising processing circuitry, and a memory coupled with at least one processor, wherein at least one processor, individually or in any combination, is configured to cause the non-AP STA to: select a target Access Point (AP) from one or more candidate APs during a roaming procedure; transmit a first reconfiguration request message to the AP, during the roaming procedure, wherein the first reconfiguration request message comprises at least one of a roaming phase type, an Identifier (ID) of the selected target AP indicating Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets, wherein the AP comprises one of a source AP or the selected target AP; receive a first reconfiguration response message from the AP, based on the transmitted first reconfiguration request message, in which the first reconfiguration response message comprises at least a Down Link (DL) drain time of the selected target AP, wherein the DL drain time is set based on QoS requirements indicated in the first reconfiguration request message; and manage the low-latency communication in the communication network, based on the received first reconfiguration response message.

According to an example embodiment, the present disclosure provides a method of managing low-latency communication in a communication network. The method comprises: receiving, by an Access Point (AP), a first reconfiguration request message from a non-Access Point station (non-AP STA), during an execution phase of the roaming procedure, wherein the first reconfiguration request message comprises at least one of a roaming phase type indicating the execution phase, an Identifier (ID) of a selected target AP indicating a Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets, wherein the AP includes one of a source AP or the selected target AP; and transmitting, by the AP, a first reconfiguration response message to the non-AP STA, based on the received first reconfiguration request message, to manage low-latency communication in the communication network, wherein the first reconfiguration response message comprises a Down Link (DL) drain time of the selected target AP, and the DL drain time is set based on QoS requirements indicated in the first reconfiguration request message.

According to an example embodiment, the present disclosure provides an Access Point (AP) for managing low-latency communication in a communication network. The AP comprises: at least one processor, comprising processing circuitry, and a memory coupled with at least one processor, wherein at least one processor, individually or in any combination, is configured to cause the AP to: receive a first reconfiguration request message from a non-Access Point station (non-AP STA), during an execution phase of the roaming procedure, wherein the first reconfiguration request message comprises at least one of a roaming phase type indicating the execution phase, an Identifier (ID) of a selected target AP indicating a Media Access Control (MAC) address, and a Quality of Service (QoS) characteristics of the non-AP

STA comprising at least one of number of queued low latency packets, expiration time of the low latency packets, and Quality Of Service (QoS) requirements of the low latency packets, wherein the AP includes one of a source AP or the selected target AP; and transmit a first reconfiguration response message to the non-AP STA, based on the received first reconfiguration request message, to manage low-latency communication in the communication network, wherein the first reconfiguration response message comprises a Down Link (DL) drain time of the selected target AP, and wherein the DL drain time is set based on QoS requirements indicated in the first reconfiguration request message.

According to an example embodiment, the present disclosure provides a method of managing low-latency communication in a communication network. The method comprises: transmitting, by an Access Point (AP), a negotiation request message to one or more candidate co-ordinated APs, wherein the AP includes a co-ordinating AP, and the negotiation request message comprises a Low Latency Indication (LLI) support flag; receiving, by the AP, requirements related to QoS characteristics from the one or more candidate co-ordinated APs, based on the transmitted negotiation request message, wherein the QoS characteristics correspond to latency requirements of respective non-AP STA associated with each of the one or more candidate co-ordinated APs, and wherein QoS characteristics comprises a number of queued low latency packets, expiration time of the low latency packets, and Quality Of Service (QoS) requirements of the low latency packets including traffic flows and associated minimum and maximum service times; and transmitting, by the AP, one or more allocation resources to each of the one or more candidate co-ordinated APs, based on the received requirements related to the QoS characteristics, for managing low-latency communication in a communication network.

The foregoing summary is illustrative and is not intended to be in any way limiting. In addition to the embodiments, and features described above, further aspects, embodiments, and features will become apparent by reference to the drawings and the following detailed description.

### BRIEF DESCRIPTION OF THE DRAWINGS

The above and other aspects, features and advantages of certain embodiments of the present disclosure will be more apparent from the following detailed description, taken in conjunction with the accompanying drawings. in which:

FIGS. 1A, 1B, 1C and 1D are diagrams illustrating existing approaches for managing low-latency communication in a communication network, according to conventional technology;

FIG. 2 is a diagram illustrating an environment for managing low-latency communication in a communication network, according to various example embodiments;

FIG. 3 is a block diagram illustrating an example configuration of a non-Access Point station (non-AP STA) for managing low-latency communication in a communication network, according to various example embodiments;

FIG. 4 is a block diagram illustrating an example configuration of an Access point (AP) for managing low-latency communication in a communication network, according to various example embodiments;

FIG. 5 is a signal flow diagram illustrating example operations of selecting a target AP, from the one or more candidate APs, according to various embodiments;

FIG. 6 is a diagram illustrating an example data format of a second reconfiguration request message, according to various example embodiments;

FIG. 7 is a diagram illustrating an example data format of second reconfiguration response message, according to various example embodiments;

FIG. 8 is a signal flow diagram illustrating example operations of managing low-latency communication in a communication network, according to various example embodiments;

FIG. 9 is a signal flow diagram illustrating example operations of managing low-latency communication in a communication network, according to various example embodiments;

FIG. 10 is a diagram illustrating an example data format of a first reconfiguration request message, according to various example embodiments;

FIG. 11 is a diagram illustrating an example data format of first reconfiguration response message, according to various example embodiments;

FIG. 12 is a flowchart illustrating example operations of setting DL drain time, according to various example embodiments;

FIG. 13 is a signal flow diagram illustrating example operations of managing low-latency communication in a communication network, according to various example embodiments;

FIG. 14 is a diagram illustrating an example data format of a MAPC negotiation request/MAPC negotiation response, according to various example embodiments;

FIG. 15 is a flowchart illustrating an example method for managing low-latency communication in a communication network, according to various example embodiments;

FIG. 16 is a flowchart illustrating an example method for managing low-latency communication in a communication network, according to various example embodiments; and

FIG. 17 is a flowchart illustrating an example method for managing low-latency communication in a communication network, according to various example embodiments.

It should be appreciated by those skilled in the art that the block diagrams herein represent conceptual views of illustrative systems illustrating various principles of the present disclosure. It will be appreciated that any flowcharts, flow diagrams, state transition diagrams, pseudo code, and the like represent various example processes which may be substantially represented in a non-transitory computer-readable medium and executed by a computer or processor, whether or not such computer or processor is explicitly shown.

### DETAILED DESCRIPTION

The present disclosure generally relates to wireless communication networks. For example, the present disclosure relates to a system and method to handle low latency delay report in multi-access point (multi-AP) environments.

Low Latency applications are gaining traction in the user ecosystem with development of extended reality (XR), gaming (cloud and real-time), industry automation etc. The Institute of Electrical and Electronics Engineers IEEE 802.11bn task group is developing features to support high reliability for such low latency applications and use cases. Such application requires low latency and high reliability to provide a seamless user experience. A low latency indication (LLI) support is defined to support the indication of low latency needs from non-AP station (STA) to access point (AP) so that the AP can schedule the non-AP STA that has low latency needs better and reduce the loss of packets due to packet timer expiry.

Multiple new use cases such as real-time gaming, cloud gaming, robotics, industrial automation, XR have stringent latency requirements. The IEEE Task group is defining specifications in the 802.11bn task group to improve the latency compared to previous 802.11be specification and has to this effect defined it as one of the goals to be met for completing the specification on 802.11bn. One of the agreements amongst the set of proposals in 11bn group is to introduce the Low Latency Indication (LLI) from a Transmit Opportunity (TXOP) responder to a TXOP holder.

AP as a TXOP holder which sends an Initial Control Frame (ICF) before transmitting data and the non-AP STA as a TXOP responder transmits an Initial Control Response (ICR) frame which carries the LLI to indicate to the AP that the non-AP STA has low latency packets pending in its buffer. Upon receiving the LLI in the control response frame, the TXOP holder considers the LLI in determining subsequent actions within the current TXOP or subsequent TXOPs.

The response frame can be a Multi-STA Block Ack (M-STA-BA) which carries the LLI which can help communicate the low latency needs of the TXOP responder or non-AP STA. The LLI is included in the feedback field of the feedback Per AID TID information. To be determined bits in 4-octet block Ack Bitmap field is defined to provide the low latency need. Hence, in existing techniques the M-STA-BA is identified as a control response frame or ICR that can carry the low latency needs from the TXOP responder. However, it is still to be determined on what the LLI report should contain.

The traffic related information of the non-AP STA is reported to the AP via different frameworks like Buffer Status Report (BSR) or Quality of service (QoS) setup. The BSR assists the AP in allocating the resources while the QoS helps in defining the traffic flow characteristics. However, these frameworks do not provide the timing information of the packet (e.g. queuing time, expiration time, HOL delay etc.)

If STA 1 has packets P11 to P13 expiring at time t2 and STA2 has P21 to P23 packets expiring at time t1, the AP is unaware of this expiration time, and the AP may schedule STA1 first. After t1, when AP schedules STA2, its packets have expired, and it has lost the opportunity to send the packets in time which results in packet loss and hence a reliability issue for low latency packets.

The MAC Service Data Unit (MSDU) MSDU 1 to MSDU 4 have different expiration times T1 to T4. Given that T1<T2<T3<T4, without expiration time, some packets may get expired before transmission opportunity. Hence with expiration time, the buffer can be reordered to send packets with lowest expiration time first.

Considering the above prior art techniques, the group 11bn discussed introducing a Low Latency Delay Report that can include the expiration time of the buffered low latency MSDUs to the AP so that the AP is aware of the scheduling and timing requirements at the non-AP STA. The container and expressing of such a report are to be determined.

The LLI is used to indicate that low latency packets are buffered at the TXOP responder side and low latency delay report is used to indicate that the buffered low latency packets have an expiration time and these two information can aid the scheduling of low latency packets with minimal packet loss. It is to be determined how the low latency delay report is sent to the AP.

In yet another prior art technique, a seamless roaming is defined which is a mechanism defined in 11bn specification, for a non-AP MLD to transition from its current AP Multi Link Device (MLD) to a target AP MLD without requiring reassociation and minimizing and/or reducing the time during which connectivity between the non-AP MLD and the Distribution System (DS) is lost.

The roaming preparation and execution phase involves context transfer in each phase depending on whether the context is near static or dynamic in nature. The following context can be transferred as per agreements so far:
The block ack parameters and block ack timeout value for any block ack agreement on each TID.
The next SN to be assigned for DL individually addressed data frame of each TID.
The latest duplicate receiver cache for each TID without block ack agreement.
The latest SN that has been passed up for each TID with UL block ack agreement.
The starting PN to be assigned for DL individually addressed frame by the target AP MLD (this is not needed in the case a per-AP MLD TK is used).
The initial value to be used by each replay counter of the target AP MLD for UL individually addressed frame.
WinStartO of each existing DL block ack agreement.

The seamless roaming mechanism ensures that the non-AP MLD transitions from source AP MLD to target AP MLD with minimal loss and to enable this, context transfer is done from source to target AP MLD during roaming preparation and execution phase.

In yet another prior art technique, the coordinated time division multiple access (Co-TDMA) procedure enables the AP to share a time portion of an obtained TXOP with another AP that belongs to a set of APs to transmit one or more PPDUs.

In this prior art technique, the sharing AP which obtains TXOP is called as the polling AP and it polls the other APs in the set if it requires a portion of the TXOP. The polled APs respond to the Polling AP and then exchange of data happens with the TXOP shared from the polling AP to the polled AP(s). There is a multi-AP mechanism defined to share the obtained TXOP between multiple APs so that those APs can service the non-AP STAs in their own BSS.

The current proposal and agreements in 802.11bn have been discussing, including such a low latency indication support only between a non-AP STA and it's corresponding AP. But it is still not specified how the existing techniques consider multiple scenarios such as explained below which needs design of a complete framework of low latency indication:

### Design of Frame to Indicate LLI for Multiple Scenarios:

From a source AP MLD to a Target AP MLD
From a coordinated AP to a Coordinating AP

### Message Sequences:

How can a non-AP STA indicate low latency needs when it is in transition from one AP to another AP due to Roaming conditions
How can two or a set of APs co-ordinate the low latency needs for all the non-AP STAs in their BSS
Design of frame format, contents, message sequences in above said scenarios.

Hence, there is a need to address the above-mentioned drawback(s) and addresses the above mentioned scenarios.

In the present disclosure, systems, and methods to handle low latency delay report are disclosed. Various example embodiments herein disclose methods and systems to handle low latency delay report in multi-access point (multi-AP) environments.

In an embodiment, the present disclosure provides a Low Latency Indication (LLI) framework to address a plurality of solutions for each of the seamless roaming and the Multi-AP Co-ordination Framework. Embodiments of the present disclosure further provide solutions during seamless roaming for each of the roaming preparation phase, roaming execution phase (via source and target AP MLDs), and context transfer, with each phase utilizing specific link reconfiguration requests and responses through multi-link elements.

In an embodiment, the present disclosure provides a multi-AP coordination Framework which includes an M-APC Negotiation Phase and a Polling and Allocation Phase, where various example embodiments of the present disclosure provide solutions such as MAPC Negotiation Request/Response and M-STA-BA as ICR with Low Latency Delay Report.

In the present disclosure, the word “exemplary” is used herein to refer to “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, various example embodiments are shown by way of example in the drawings and will be described in greater detail below. It should be understood, however that it is not intended to limit the disclosure to the particular forms disclosed, but on the contrary, the disclosure is to cover all modifications, equivalents, and alternatives falling within the scope of the disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The various embodiments herein achieve systems and methods to handle low latency delay report. Accordingly, example embodiments herein disclose systems and methods to handle low latency delay report. The disclosure provides methods and systems for including low latency indication information in different procedures such as seamless roaming, multi-AP coordination and includes definition of frame(s) and frame format and contents.

In the context of seamless roaming when low latency packets are involved at a non-Access Point Multi-Link Device (non-AP MLD), there is a need to define a framework that enables low latency packets are prioritized during the roaming procedure. Once the non-AP MLD decides to roam, during the roaming preparation phase, it is possible that multiple target AP MLDs are available for the non-AP MLD, but not all target AP MLDs may be suitable to support low latency needs at non-AP MLD. Hence there needs to be a mechanism by which target AP MLD that may support low latency needs be chosen.

Further this context needs to be transferred from the source AP MLD to the set of target AP MLDs so that they may prepare for the non-AP MLD including the aspect of low latency. Hence there is a need to define a mechanism to enable the context transfer from source AP MLD to Target AP MLD(s).

During the roaming execution phase, the uplink (UL) data stops and hence this is where the buffer at the non-AP MLD starts accumulating MAC Protocol Data Units (MPDUs) including the ones with low latency needs. Hence there is a need to transfer the low latency information, like the delay report or expiration time as part of context transfer. Finally, what procedures may help the low latency packets get uplink trigger before expiration needs to be addressed after the roaming execution phase is completed.

In a M-AP coordination scheme like Co-TDMA, a negotiation phase occurs following discovery that M-AP coordination procedure is possible. During the negotiation phase, for effective scheduling and supporting high reliability for low latency applications, it is required to design a procedure such that the co-ordinated APs indicate whether they support low latency indication. The method, frame and frame format for such information exchange needs to be designed.

Further during the polling phase, when the polling AP sends an Initial Control Frame (ICF), if the polled APs can additionally indicate if their own station(s) have low latency needs in the Initial control response frame (ICR). The polled AP(s) need to be able to send the low latency needs of their own station(s) in the response to polling and design of such a frame and frame format needs to be done.

With this information from the polled AP(s), the polling AP may effectively schedule the TXOP allocation to support the low latency needs of the polled AP(s). to the disclosure includes a method and approach to handle the response from the polled AP by the polling AP and take effective decision of TXOP sharing. In an embodiment, this procedure may also be applied to other co-ordination procedures where applicable (e.g. C-RTWT).

During the seamless roaming preparation phase, multiple target AP MLDs may be prepared. However, it is possible that not all the target AP MLDs support the low latency indication. Hence the disclosure provides that the non-AP MLD may identify and prepare those target AP MLDs which support LLI to support the low latency requirements of the non-AP MLD.

The non-AP MLD may identify by UHR Capabilities in the discovery phase whether the target AP MLD may support the low latency indication. Hence once the non-AP MLD decides to roam, a link reconfiguration request message may be sent with type set to preparation.

In an embodiment, the link reconfiguration request shall contain the following to support low latency:
Low Latency Indication Support field which may be set to value 1 or TRUE and sent to source AP MLD.
The Source AP MLD, transfers the context to the identified target AP MLD1. The context to be transferred shall contain:
Low Latency Indication Support (apart from other baseline context related information)

The process may be repeated with all the target AP MLDs that support low latency indication. Further in the link reconfiguration response message received after the respective target AP MLD may be prepared, the following information may be included:
Profile: Low Latency Indication Status
   Accepted complete,
   or Accept partial,
   or Rejected

When the target AP MLDs that support low latency all send a failure or LLI status as rejected, the non-AP MLD may send a preparation request using baseline procedures.

Link Reconfiguration Request a protected Extremely High Throughput (EHT) action frame. The action field of a link reconfiguration request frame contains reconfiguration multi-link element.

In the disclosure, during roaming preparation phase, the link reconfiguration request may be used to set the QoS Requirement (e.g. low latency indication) along with other baseline solutions that include type of roaming phase as preparation and target MLD MAC address is included for which the non-AP MLD wants to prepare for the seamless roaming.

In the disclosure, the frame format extension for reconfiguration multi-link element is provided.

In an embodiment, the multi-link control may include:
a reserved bit that can be repurposed to indicate whether the Roaming phase is preparation or execution.
   Roaming Phase Type 0 can indicate Preparation phase
   Roaming Phase Type 1 can indicate Execution phase.

In an embodiment, the multi-link control may include:
a presence bitmap which is enhanced to further include presence indicators: Bit 4 indicates whether Target AP MLD ID/Address is present.
Bit 5 indicates whether QoS Requirement is present.

The common Information is extended as below:
Target MLD ID/Address if present indicates the Identifier and/or Address (e.g. MAC Address) of the target AP MLD. The expression of the ID/Address is developed as specification progresses.
QoS Requirement may indicate various QoS or special requirements that the Non-AP MLD wishes to prioritize. The value of QoS requirement is as per Table 1 below

TABLE 1

| Value | Name |
|---|---|
| 1 | Low Latency Indication Present |
| 0, 2 to 31 | Reserved (for future use) |

In an embodiment the disclosure provides a method by which the low latency indication may be sent by non-AP MLD is indicated and it wishes to prioritize the low latency traffic and hence sets this value to 1 to indicate the same.

The link reconfiguration response is a protected EHT Action Frame. The action field of the link reconfiguration response frame contains basic multi-link element.

In the disclosure, during roaming preparation phase, the link reconfiguration response may be used to set the profile for LLI status along with other baseline solutions that include success or failure of the associated link reconfiguration request. In this solution, frame format extension for Basic Multi-link element is disclosed as per below description:

In an embodiment, the multi-link control may include:
a reserved bit that can be repurposed to indicate whether the Roaming phase is preparation or execution.
Roaming Phase Type 0 can indicate Preparation phase
Roaming Phase Type 1 can indicate Execution phase.

In an embodiment, the multi-link control may include:
a presence bitmap which is enhanced to further include presence indicators:
Bit 7 indicates whether QoS Indication Status is present.

The Common Information is extended as below:
QoS Indication status is defined in Common Information, and it is present if the Bit 7 is indicated as present in multi-link control. The value of the QoS indication Status is as per Table 2 below:

TABLE 2

| Value | Name |
|---|---|
| 1 | QoS Indication Status Accepted |
| 2 | QoS Indication Status Rejected |
| 3 | QoS Indication Status Accepted - Partial |
| 0, 4 to 31 | Reserved (for future use) |

The QoS indication in the disclosure is for the low latency indication or more generally to the QoS value that was indicated in the link reconfiguration request. A complete accept may refer, for example, to the low latency indication being fully supported by the target AP MLD, while a partial accept may refer, for example, to the Target AP MLD being ready to accept the roaming transition, but cannot guarantee QoS indication and a complete reject indicates that the Target AP MLD is not ready to accept the non-AP STA with the QoS requirements at all.

In an embodiment, during the seamless roaming execution procedure, the non-AP MLD stops sending all Uplink Data and sends a link reconfiguration request with type set to execution. In the disclosure, along with the baseline requirements of sending execution type, low latency delay report may be included. The contents of low latency delay report may be the expiration time of the MSDU or MPDU.

In an embodiment, context transfer may be done between the source and target AP MLD identified in the link reconfiguration request frame. The context to be transferred is described in the subsequent sections which will also include the low latency delay report.

In an embodiment, the source AP MLD shall respond with a link reconfiguration response message after context transfer is completed and includes a result of success or failure. Along with that the baseline requirements suggest including downlink (DL) Drain Time. This is the time for which the DL data will be delivered to the non-AP MLD via source AP MLD.

In the disclosure, the source AP MLD may set the DL Drain Time using the low latency delay report. The disclosure may consider the lowest expiration time of the low latency delay report and set the DL Drain time to a value lesser than that and ensure that the uplink data packets can get sufficient time to be sent to Target AP MLD. The target AP MLD, which is also aware of the expiration times in low latency delay report, may immediately trigger uplink packets first and then transfer the remaining DL packets.

In an embodiment, during the seamless roaming execution procedure, the non-AP MLD stops sending all uplink data and sends a link reconfiguration request with type set to execution and sent to target AP MLD. In the disclosure, along with the baseline requirements of sending execution type, low latency delay report may be included. The contents of low latency delay report may be the expiration time of the MSDU or MPDU.

In an embodiment, context transfer may be done between the source and the target AP MLD identified in the Link reconfiguration request frame. The context to be transferred is described in the subsequent section which will also include the low latency delay report. The target AP MLD shall respond with a link reconfiguration response message after context transfer is completed and includes a result of success or failure. Along with that the baseline requirements suggest including DL Drain Time. This is the time for which the DL data shall be delivered to the non-AP MLD via source AP MLD.

In the disclosure, the target AP MLD can set the DL Drain Time using the low latency delay report. The disclosure may consider the lowest expiration time of the low latency delay report and set the DL Drain time to a value lesser than that and ensure that the uplink data packets can get sufficient time to be sent to the target AP MLD. The target AP MLD, which is also aware of the expiration times in low latency delay report, can immediately trigger uplink packets first and then transfer the remaining DL packets.

In an embodiment, the link reconfiguration request is a protected EHT Action Frame. The action field of the link reconfiguration request frame may contain reconfiguration multi-link element. In the disclosure, during roaming preparation phase, link reconfiguration request may be used to set the QoS parameters (e.g. low latency delay report) along with other baseline solutions that include type of Roaming phase as preparation and target MLD MAC address may be included for which the non-AP MLD wants to prepare for the seamless roaming. In the disclosure, frame format extension for reconfiguration multi-link element may be as illustrated below description as follows:

In an embodiment, the multi-link control may include:
a reserved bit that can be repurposed to indicate whether the roaming phase is preparation or execution.
Roaming Phase Type 0 can indicate Preparation phase
Roaming Phase Type 1 can indicate Execution phase.

In an embodiment, the multi-link control may include:
a presence bitmap which is enhanced to further include presence indicators:
Bit 4 indicates whether Target AP MLD ID/Address is present.
Bit 5 indicates whether QoS Parameters is present.

The Common Information is extended as below:
Target (or Source) MLD ID/Address if present indicates the Identifier and/or Address (e.g. MAC Address) of the Target (or Source) AP MLD. The expression of the ID/Address is developed as specification progresses.
QoS Parameters may indicate various QoS or special requirements that the non-AP MLD wishes to prioritize.

In an embodiment, to the disclosure may indicate the low latency delay report, and it may include the number of MSDU or MPDUs that are in the queue with a low latency requirement, further it may include the expiration time indicators. The expiration time may be an expression of lowest expiration time or earliest expiration time and then with highest expiration time or latest expiration time of the packets. Further an average expiration time may also be included. One or multiple of these values may be included based on the need. A 9-bit time indication value may be considered per baseline rules for expression of time.

In an embodiment, the link reconfiguration response is a protected EHT action Frame. The action field of the link reconfiguration response frame may contain basic multi-link element. In the disclosure, during roaming preparation phase, the link reconfiguration response may be used to set the profile for low latency indication status along with other baseline solutions that include success or failure of the associated link reconfiguration request.

In the disclosure, a frame format extension for basic multi-link element may be as illustrated below:

In an embodiment, the multi-link control may include:
a reserved bit that can be repurposed to indicate whether the roaming phase is preparation or execution.
Roaming Phase Type 0 can indicate Preparation phase
Roaming Phase Type 1 can indicate Execution phase.

In an embodiment, the multi-link control may include:
a presence bitmap which is enhanced to further include presence indicators:
Bit 7 indicates whether QoS Parameters is present.

In an embodiment, the Common Information is extended as below:
The QoS parameters may include the
DL Drain Time: This drain time basically allows a certain period of time until which the DL Data can be sent to the non-AP MLD from source AP MLD after Roaming execution phase has started.

The present disclosure here may set the DL Drain time based on the Expiration times sent in Link Reconfiguration Request during execution phase.

The source AP MLD may set up a small time for DL Drain time which is lesser than the least value of Expiration time as an example and help the low latency packets in the queue during a roaming phase.

The non-AP MLD detects roaming condition and prepares the target AP MLD via source AP MLD. The roaming execution may occur either via the source AP MLD or target

AP MLD. In either case, in an embodiment, three options are discussed to set the DL Drain Timer.

In option 1: The DL Drain timer is set to a value less than the least value of the expiration timer of the MSDU in queue

In option 2: The DL Drain timer is set to an average value of the expiration timer

In option 3: The DL Drain timer is set to a value less than the maximum expiration timer.

In an embodiment, the three options may be provided so that the AP MLD may decide based on scheduling constraints and still maximize and/or improve the low latency delay requirements at the non-AP MLD. This also provides more flexible design option for the AP MLD.

A DL Drain timer is set and transmitted via link reconfiguration response message via either the source or target AP MLD based on the procedure that is supported. The Downlink data may be then sent via the source AP MLD till the DL drain timer expires. The target AP MLD may trigger sending uplink data to the non-AP MLD immediately so that it may maximize and/or improve performance for the low latency packets.

In an embodiment, the present disclosure illustrates context transfer during seamless roaming, in accordance with various embodiments of the present disclosure. Context Transfer occurs between the source AP MLD and the target AP MLD during both preparation and execution phase and the specification or baseline available so far covers the following:

The following context may be transferred to the target AP MLD:
The block ack parameters and block ack timeout value for any block ack agreement on each TID.
The next SN to be assigned for DL individually addressed data frame of each TID.
The latest duplicate receiver cache for each TID without block ack agreement.
The latest SN that has been passed up for each TID with UL block ack agreement.
The starting PN to be assigned for DL individually addressed frame by the target AP MLD.
The initial value to be used by each replay counter of the target AP MLD for UL individually addressed frame.
WinStartO of each existing DL block ack agreement.

In the disclosure, the following are also considered to be added in the context transfer:
The QoS Requirement indicator value (e.g.: Low Latency Indicator value)
The Associated QoS Requirement parameters (e.g.: Low Latency Delay Report)
The expression of the low latency delay report can include the lowest, average and highest expiration time including the number of MSDUs in the queue with low latency requirement.

In a M-AP Co-ordination scheme, multiple APs may co-ordinate to share time resources in schemes like C-TDMA. However, if the time resources are shared without the knowledge of pending low latency data traffic with any of the AP(s) and its non-AP STA(s) then, it would lead to inefficient scheduling and performance impact due to expiration of low latency packets. Hence in the disclosure the changes to the M-AP Co-ordination framework to include the low latency information support, low latency indication and associated report.

During the MAP-C discovery procedure, the AP(s) discover the M-AP co-ordination features that each AP supports and then it moves to the negotiation phase where the profile and schemes of particular feature are exchanged.

In the current baseline, the MAPC Negotiation Request message is defined to indicate the MAPC capabilities like C-TDMA, C-BF, C-RTWT etc. However, these capabilities do not include information about the QoS requirements of the AP and its non-AP STA(s). In the present disclosure, the MAPC Negotiation Request and MAPC Negotiation Response messages shall carry the QoS Requirement support (e.g. low latency indication support) to indicate that these AP and its non AP STA(s) have low latency indication support and further co-ordination shall take into account the low latency indication support as well.

The MAPC Negotiation Request/Response are public Ultra High Reliability (UHR) action frames. The MAPC Negotiation Information within MAPC Negotiation Request/Response frame contains a MAPC element.

In an embodiment, during the MAPC Negotiation Phase, the MAPC Negotiation Request may be sent to negotiate the MAPC parameters for particular co-ordination schemes in consideration. In response the co-ordinated AP(s) respond with MAPC negotiation response. According to baseline specification, the MAPC Common Info carries the MAPC capabilities which are related to particular MAPC schemes like C-TDMA, C-BF etc.

However, in addition to these capabilities, the AP(s) may need to further exchange some more capabilities like in the case of low latency that the AP and it's STAs support low latency indication.

When such indication for handling low latency data packets may be possible, then it should be exchanged between the AP(s) for better co-ordination in time sharing schemes like C-TDMA so that low latency expiring packets get sufficient air time and the performance is not hampered.

The following description is given to disclose various changes in the frame formats to include low latency indication support.

In an embodiment, the MAPC control may include:
a presence bitmap which is enhanced to further include presence indicators:
Bit 4 indicates whether Additional Capabilities field is present.

In an embodiment, the MAPC Common Information is extended as below: Additional Capabilities Information is included, and the presence bit is set accordingly.

The additional capabilities may include any capabilities that the AP wishes to exchange between themselves. In the disclosure, a one bit indicator is defined to indicate that the AP and at least one of its STA support the low latency indicator support and wishes to communicate the same with other AP(s).

Hence during negotiation phase, the MAPC element may include this capability and when a co-ordinating AP is sending this request, it may include it in the MAPC common information in additional capabilities. Similarly, the responding AP(s) may include the MAPC common information with additional capabilities like low latency indication support to indicate that the AP and its STAs support the same. When the field is absent, it may be considered that the AP does not intend to support low latency indication. The disclosure may be extended to other capabilities required for other features as well.

In Co-TDMA scheme, after the MAPC negotiation phase, the polling phase includes transmission of an ICF-ICR sequence between the polling AP and polled AP(s). In the disclosure, the ICR carries a low latency delay report that includes the expiration times of the MSDUs with low latency requirements. The expression of the expiration time may be lowest expiration time, average expiration time and/or maximum expiration time.

The ICR carries the Low latency delay report in addition which includes an expression of the expiration times. Now polling AP1 has visibility of expiration times and may schedule AP2 before AP3 to facilitate low latency packet expiry at AP2.

The BA Control has BA Type set to M-STA BA. The BA information has per AID TID Information. The per AID TID Information has AID TID information (which has AID11, Ack Type, TID), BA Starting Sequence control (which has fragment number and starting sequence) and BA Bitmap. The Fragment number identifies the length of the BA bitmap for Block Ack purposes.

In an embodiment, during the polling phase, an ICF-ICR may be exchanged between the AP(s). The ICR may be chosen to be Multi-STA-BlockAck (M-STA-BA) which is repurposed to indicate the Co-TDMA response to ICF.

The M-STA-BA may contain a Per-AID-TID info, which has BlockAckBitmap. In order to include low latency delay report, in addition to other information in Co-TDMA response, Block Ack Bitmap may contain the Number of MSDU/MPDs with low latency indication, lowest expiration time, average expiration time, maximum expiration time. The Block Ack Bitmap may contain one or multiple such time values. A 9 bit time indication value may be considered per baseline rules for expression of time.

These and other aspects of various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure herein without departing from the spirit thereof, and the disclosure includes all such modifications.

The various example embodiments herein and the various features and advantageous details thereof are explained more fully with reference to the various example embodiments that are illustrated in the accompanying drawings and detailed in the following description. Descriptions of well-known components and processing techniques may be omitted so as to not unnecessarily obscure the disclosure. The examples used herein are intended merely to facilitate an understanding of ways in which the various embodiments herein can be practiced. Accordingly, the examples should not be understood as limiting the scope of the disclosure.

The various example embodiments disclosed herein can be implemented through at least one software program running on at least one hardware device and performing network management functions to control the elements. The elements can be at least one of a hardware device, or a combination of hardware device and software module.

A description of an embodiment with several components in communication with each other does not imply that all such components are required. On the contrary, a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, various embodiments of the disclosure need not include the device itself.

The language used in the disclosure has been selected for readability and instructional purposes, and it may not have been selected to delineate or circumscribe the disclosed subject matter. Accordingly, the disclosure is intended to be illustrative, but not limiting, of the scope of the disclosure.

While various aspects and embodiments have been disclosed herein, other aspects and embodiments will be apparent to those skilled in the art. The various aspects and embodiments disclosed herein are for purposes of illustration and are not intended to be limiting.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description, reference is made to the accompanying drawings that form a part hereof, and in which are shown by way of illustration various embodiments in which the disclosure may be practiced. The following description is, therefore, not to be taken in a limiting sense.

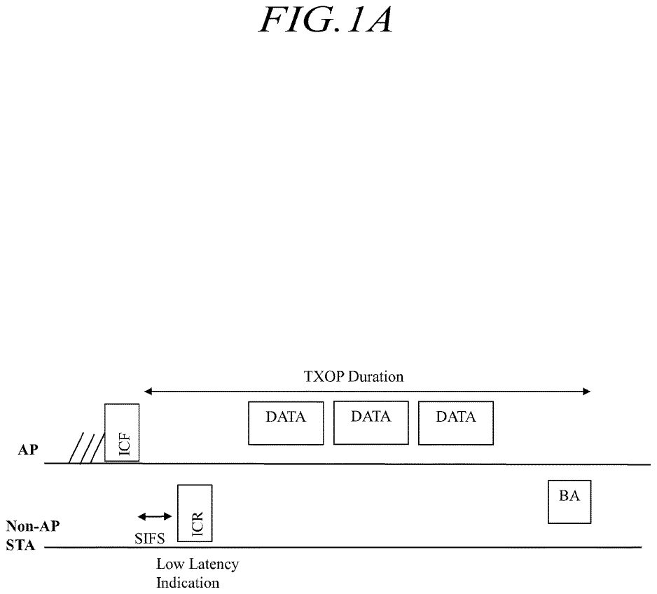

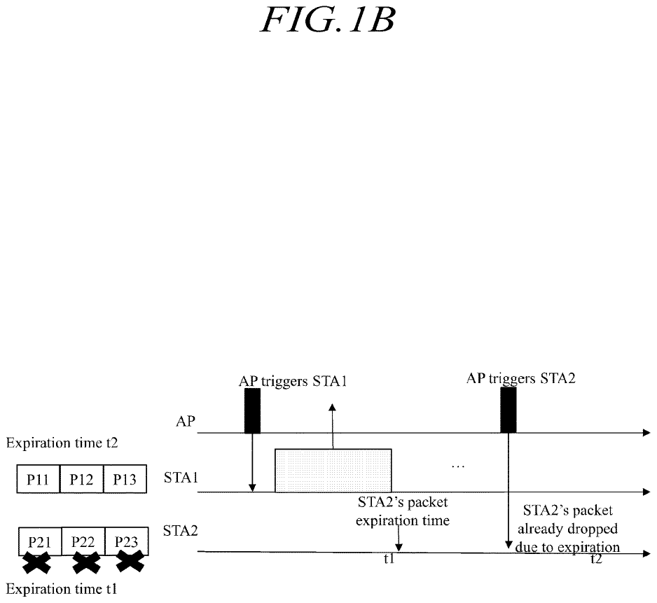

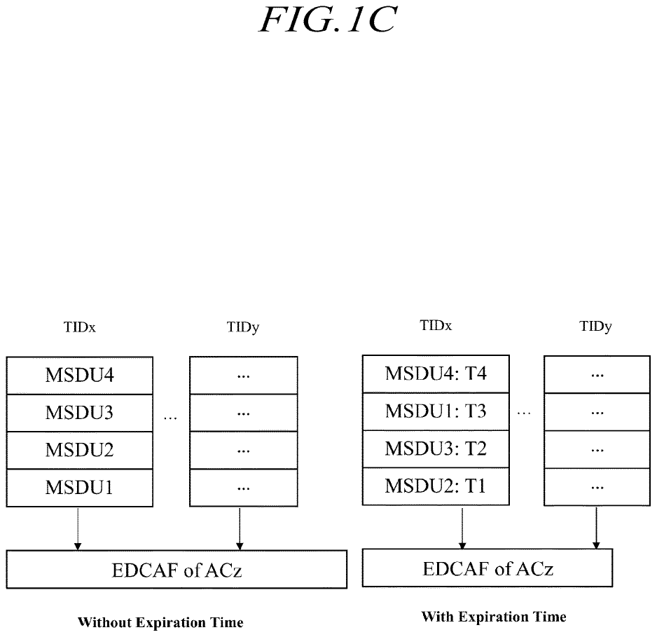

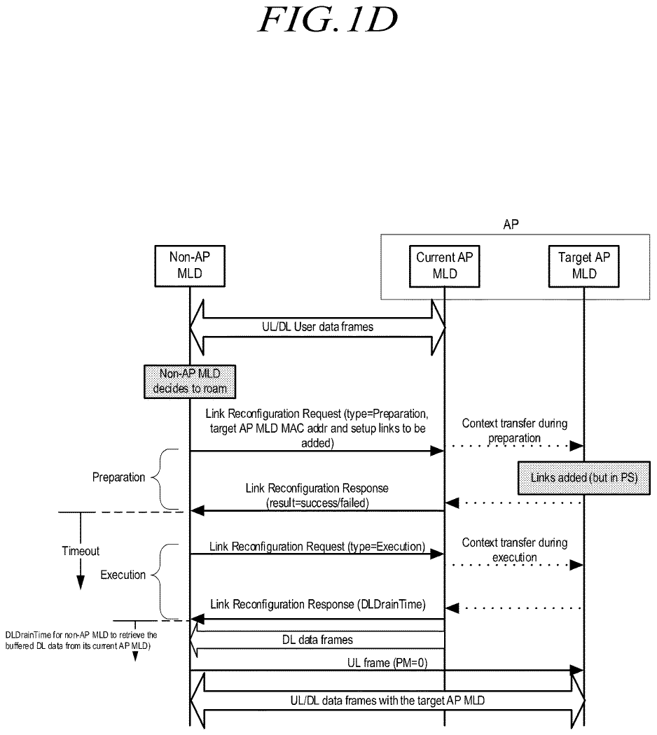

FIGS. 1A, 1B, 1C and 1D are diagrams illustrating existing approaches for managing low-latency communication in a communication network, according to conventional technology.

Multiple new use cases are coming up such as Real-time gaming, Cloud gaming, Robotics, Industrial automation, XR use cases and so on that have stringent latency requirements. The existing systems are working on to improve the latency requirements. One of the agreements is to introduce a Low Latency Indication (LLI) from a Transmit Opportunity (TXOP) responder to a TXOP holder. As shown in FIG. 1A, an AP as a TXOP holder sends an Initial Control Frame (ICF). Before transmitting data and the non-AP STA as a TXOP responder, transmits an Initial Control Response (ICR) frame which carries a low latency Indication to indicate to AP that the non-AP STA has low latency packets pending in buffer. Upon receiving the low latency indication in the control response frame, the TXOP holder consider the low latency indication in determining subsequent actions within the current TXOP or subsequent TXOPs. The response frame (ICR) is a Multi-STA Block Ack (M-STA-BA) which carries the low latency indication which can help communicate the low latency needs of the TXOP responder or non-AP STA as shown in FIG. 1A. M-STA-BA is identified as a Control Response Frame or ICR that can carry the low latency indication from the TXOP responder. However, there is no clarity on what the low latency indication report should contain.

In existing approaches, the traffic related information of the non-AP STA is reported to the AP via different frameworks such as Buffer Status Report (BSR) or QoS setup. BSR assists AP in allocating the resources while the QoS helps in defining the traffic flow characteristics. However these frameworks do not provide the timing information of the packet (e.g. Queuing time, expiration time, Head-of-Line (HOL) delay etc). As shown in FIG. 1B, if STA 1 has packets P11 to P13 expiring at time t2 and STA2 has P21 to P23 packets expiring at time t1, but the AP is unaware of this expiration time, AP may schedule STA1 first. Due to which when AP schedules STA2 after time t1, packets have expired and has lost the opportunity to send the packets in time which results in packet loss and hence a reliability issue for low latency packets. In another scenario, as shown in FIG. 1C, the MAC Service Data Unit (MSDU) MSDU 1 to MSDU 4 have different expiration times T1 to T4. Given that T1<T2<T3<T4, without expiration time, some packets may get expired before transmission opportunity. Hence, according to expiration time, the buffer can be reordered to send packets with lowest expiration time first. Low Latency Indication is used to indicate that low latency packets are buffered at the TXOP responder side and Low Latency Delay Report is used to indicate that the buffered low latency packets have an expiration time and these two information can aid the scheduling of low latency packets with minimal packet loss. However, the concept of how the Low Latency Delay Report is sent to AP, is still not defined.

Seamless roaming is a mechanism defined for a non-AP MLD to transition from current AP Multi Link Device (MLD) to a target AP MLD without requiring reassociation and minimizing and/or reducing the time during which connectivity between the non-AP MLD and the Distribution System (DS) is lost. As shown in FIG. 1D, Seamless Roaming procedure involves two major phases e.g., Roaming Preparation, and Roaming Execution. In one embodiment, an AP may include current AP MLD and target AP MLD. The AP may be a seamless mobility domain (SMD). The Roaming Preparation and Execution phase involves Context Transfer in each phase depending on whether the context is near static or dynamic in nature. The following Context is transferred as per agreements so far:
The block ack parameters and block ack timeout value for any block ack agreement on each Traffic Identifier (TID).
The next SN to be assigned for DL individually addressed data frame of each TID.
The latest duplicate receiver cache for each TID without block ack agreement.
The latest SN that has been passed up for each TID with Up Link (UL) block ack agreement.
The starting Packet Number (PN) to be assigned for DL individually addressed frame by the target AP MLD (this is not needed in the case a per-AP MLD TK is used).
The initial value to be used by each replay counter of the target AP MLD for UL individually addressed frame.
WinStartO of each existing DL block ack agreement.

Seamless Roaming mechanism ensures that the non-AP MLD transitions from source AP MLD to target AP MLD with minimal loss and to enable this, context transfer is done from source to target AP MLD during roaming preparation and execution phase. However, none of the information shared during the above steps include low latency information which is crucial.

In the context of Seamless Roaming when low latency packets are involved at the non-AP MLD, there is a need to define a framework that enables low latency packets to be prioritized during the roaming procedure. Once a non-AP MLD decides to roam, during the Roaming preparation phase, it is possible that multiple Target AP MLDs are available for the non-AP MLD, but not all target AP MLDs may be suitable to support low latency needs at non-AP MLD. Hence there needs to be a mechanism by which Target AP MLD that can support Low latency needs be chosen, which is missing in existing approaches. Further context needs to be transferred from the Source AP MLD to the set of Target AP MLDs to prepare for the non-AP MLD including the aspect of low latency. Hence there is a need to define a mechanism to enable context transfer from source AP MLD to Target AP MLD(s), which is missing in existing approaches. During the roaming execution phase, the UL Data stops and hence this is where the buffer at the non-AP MLD starts accumulating MAC Protocol Data Units (MPDUs) including the ones with low latency needs. Hence there is a need to transfer the low latency information, such as the delay report or expiration time as part of context transfer, which is missing in existing approaches.

A coordinated time division multiple access (Co-TDMA) procedure enables an AP to share a time portion of an obtained TXOP with another AP that belongs to a set of APs to transmit one or more PPDUs. The sharing AP which obtains TXOP is called as the polling AP and polls the other APs in the set if a portion of the TXOP if required. The polled APs respond to the Polling AP and then exchange of Data happens with the TXOP shared from the polling AP to the polled AP(s). There is a multi-AP mechanism defined to share the obtained TXOP between multiple APs so that APs service the non-AP STAs in own Basic Service Set (BSS). However, in order to efficiently manage the TXOP transfer and management several information related to low latency is required such as indication of low latency requirements from the non-AP STAs in the co-ordinated APs' BSS including the corresponding expiration time of the MPDUs/MSDUs, which is missing in existing approaches.

The disclosure provides a method and a non-Access Point station (non-AP STA) for managing low-latency communication in a communication network. The method may include selecting, by a non-Access Point station (non-AP STA), a target Access Point (AP) from one or more candidate APs during a roaming procedure. The method may further include transmitting, by the non-AP STA, a first reconfiguration request message to the AP, during the roaming procedure, in which the first reconfiguration request message comprises at least one of a roaming phase type, an Identifier (ID) of the selected target AP indicating Media Access Control (MAC) address, and Quality of Service (QoS) characteristics of the non-AP STA comprising at least one of number of queued low latency packets, expiration time of the low latency packets, and Quality Of Service (QoS) requirements of the low latency packets. The AP may include one of a source AP or the selected target AP. Further, the method comprises receiving, by the non-AP STA, a first reconfiguration response message from the AP, based on the transmitted first reconfiguration request message, in which the first reconfiguration response message comprises at least a Down Link (DL) drain time of the selected target AP. The DL drain time is set on the basis of QoS requirements indicated in the first reconfiguration request message. Furthermore, the method comprises managing, by the non-AP STA, the low-latency communication in the communication network, based on the received first reconfiguration response message.

The non-AP STA may include at least one processor, comprising processing circuitry, and a memory coupled with the processor. At least one processor, individually or in any combination, is configured to cause the non-AP STA to: select a target AP from one or more candidate APs during a roaming procedure; transmit a first reconfiguration request message to an Access Point (AP), during the roaming procedure, in which the first reconfiguration request message comprises at least one of a roaming phase type, an Identifier (ID) of the selected target AP indicating Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets. The AP comprises one of a source AP or the selected target AP. Further, at least one processor, individually or in any combination, is configured to cause the non-AP STA to: receive a first reconfiguration response message from the AP, based on the transmitted first reconfiguration request message, in which the first reconfiguration response message comprises at least a Down Link (DL) drain time of the selected target AP. The DL drain time is set on the basis of QoS requirements indicated in the first reconfiguration request message. Furthermore, at least one processor, individually or in any combination, is configured to cause the non-AP STA to manage the low-latency communication in the communication network, based on the received first reconfiguration response message.

In an embodiment, the present disclosure provides a method and an Access Point (AP) for managing low-latency communication in a communication network. The method comprises receiving, by an Access Point (AP), a first reconfiguration request message from a non-Access Point station (non-AP STA), during an execution phase of the roaming procedure, in which the first reconfiguration request message comprises at least one of a roaming phase type indicating the execution phase, an Identifier (ID) of a selected target AP indicating a Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets. The AP includes one of a source AP or the selected target AP. The method further includes transmitting, by the AP, a first reconfiguration response message to the non-AP STA, based on the received first reconfiguration request message, to manage low-latency communication in the communication network, in which the first reconfiguration response message comprises a Down Link (DL) drain time of the selected target AP. The DL drain time is set on the basis of QoS requirements indicated in the first reconfiguration request message.

The AP comprises at least one processor, comprising processing circuitry, and a memory coupled with at least one processor. At least one processor, individually or in any combination, is configured to receive a first reconfiguration request message from a non-Access Point station (non-AP STA), during an execution phase of the roaming procedure, in which the first reconfiguration request message comprises at least one of a roaming phase type indicating the execution phase, an Identifier (ID) of a selected target AP indicating a Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets. The AP includes one of a source AP or the selected target AP. At least one processor, individually or in any combination, is configured to cause the AP to transmit a first reconfiguration response message to the non-AP STA, based on the received first reconfiguration request message, to manage low-latency communication in the communication network, in which the first reconfiguration response message comprises a Down Link (DL) drain time of the selected target AP. The DL drain time is set on the basis of QoS requirements indicated in the first reconfiguration request message.

In an embodiment, the present disclosure provides a method of managing low-latency communication in a communication network. The method comprises transmitting, by an Access Point (AP), a negotiation request message to one or more candidate co-ordinated APs, in which the AP is a co-ordinating AP. The negotiation request message comprises a Low Latency Indication (LLI) support flag. The method further comprises receiving, by the AP, requirements related to QoS characteristics from the one or more candidate co-ordinated APs, based on the transmitted negotiation request message, in which the QoS characteristics correspond to latency requirements of respective non-AP STA associated with each of the one or more candidate co-ordinated APs. The QoS characteristics comprises number of queued low latency packets, expiration time of the low latency packets, and Quality Of Service (QoS) requirements of the low latency packets including traffic flows and associated minimum and maximum service times. Further, the method includes transmitting, by the AP, one or more allocation resources to each of the one or more candidate co-ordinated APs, based on the received requirements related to the QoS characteristics, for managing low-latency communication in a communication network.

The above methods provide a faster and more deterministic roaming (reduced handover latency). By selecting the target AP during a preparation phase and explicitly signalling the execution phase, the roaming operation is executed more quickly and deterministically. This reduces latency and minimizes and/or reduces service interruption during the handover. Including QoS information (e.g., number of queued low-latency packets, expiration time, latency requirements) enables the AP to tailor the Down Link (DL) drain time to the non-AP STA needs. This results in more reliable delivery of time-sensitive packets during roam.

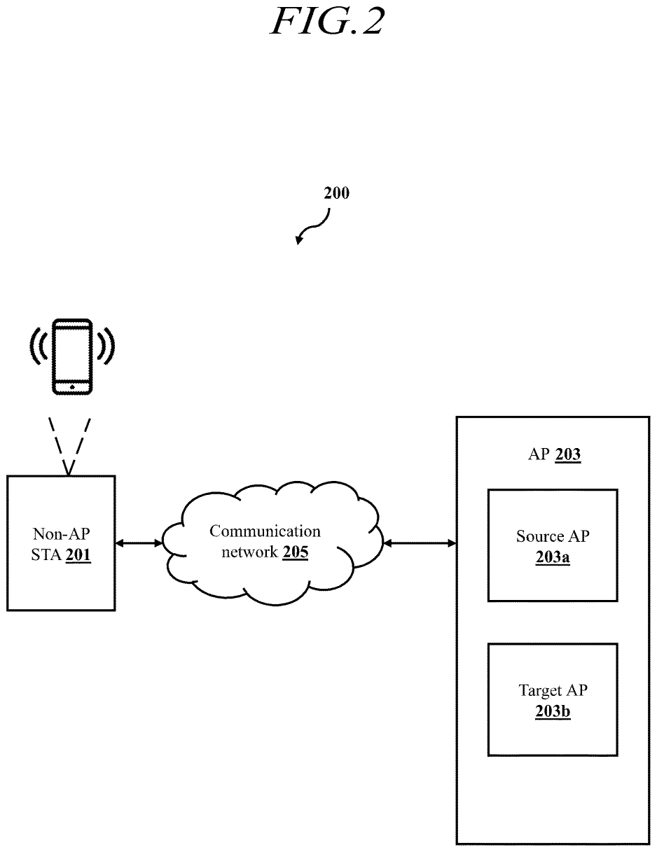

FIG. 2 is a diagram 200 illustrating an environment for managing low-latency communication in a communication network, according to various example embodiments. In one embodiment, AP (203) may include a source AP (203a) (ex: current AP MLD) and a target AP (203b) (ex: target AP MLD. The AP may be a seamless mobility domain (SMD). In an embodiment, the environment diagram 200 may comprise a non-Access Point station (non-AP STA) 201, an Access Point (AP) 203, and a communication network 205. Further, the AP 203 may comprise a source AP 203a, and a target AP 203b. In an embodiment, the non-AP STA 201 may include at least, for example, but not limited to, a mobile phone (e.g., an Android device) connecting to a Wi-Fi AP, smart sensors, smart plugs, smart thermostats, cameras, etc. Furthermore, the AP 203 may include at least for example, but not limited to, a Wi-Fi network device such as Wi-Fi router that allows wireless client devices (non-AP STAs) to connect to a wired or wireless network. Further, in an embodiment, the communication network 205 may include, for example, but not limited to, a direct interconnection, a Local Area Network (LAN), a Wide Area Network (WAN), a wireless network, a point-to-point network, or another configuration.

In an embodiment, the non-AP STA 201 may be configured to the select the target AP 203b from one or more candidate APs (not shown in FIG. 2) during a preparation phase of a roaming procedure. Further, the non-AP STA 201 may be configured to transmit a first reconfiguration request message to the AP 203, during an execution phase of the roaming procedure, in which the first reconfiguration request message comprises at least one of a roaming phase type, an Identifier (ID) of the selected target AP 203b indicating Media Access Control (MAC) address, and a Quality of Service (QoS) characteristics of the non-AP STA 201 comprising at least one of number of queued low latency packets, expiration time of the low latency packets, and Quality Of Service (QoS) requirements of the low latency packets.

Further, the non-AP STA 201 may be configured to receive a first reconfiguration response message from the AP 203, based on the transmitted first reconfiguration request message, in which the first reconfiguration response message comprises at least a Down Link (DL) drain time of the selected target AP 203b, in which the DL drain time is set on the basis of QoS requirements indicated in the first reconfiguration request message. Further, the non-AP STA 201 may be configured to manage the low-latency communication in the communication network 205, based on the received first reconfiguration response message.

In an embodiment, the AP 203 may be configured to receive a first reconfiguration request message from the non-AP STA 201, during an execution phase of the roaming procedure, in which the first reconfiguration request message comprises at least one of a roaming phase type indicating the execution phase, an Identifier (ID) of a selected target AP 203b indicating a Media Access Control (MAC) address, and a Quality of Service (QoS) characteristics of the non-AP STA 201 comprising at least one of number of queued low latency packets, expiration time of the low latency packets, and Quality Of Service (QoS) requirements of the low latency packets. Further, the AP 203 may configured to transmit a first reconfiguration response message to the non-AP STA 201, based on the received first reconfiguration request message, to manage low-latency communication in the communication network, in which the first reconfiguration response message comprises a Down Link (DL) drain time of the selected target AP 203b. The DL drain time is set on the basis of QoS requirements indicated in the first reconfiguration request message.

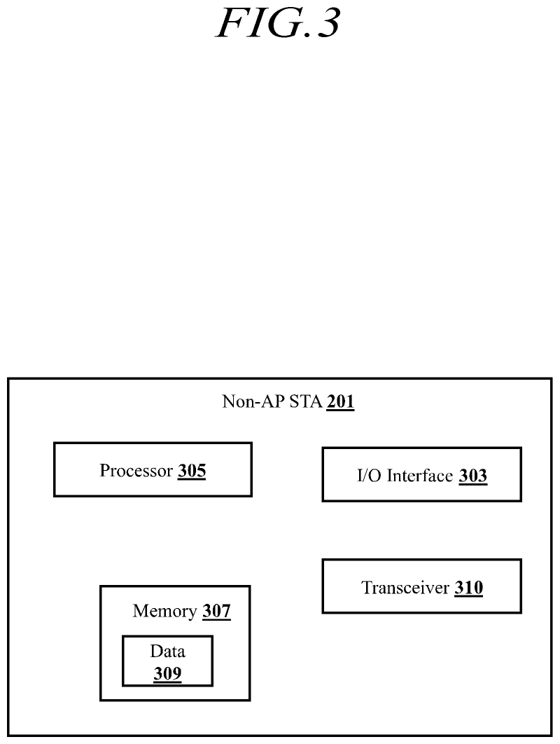

FIG. 3 is a block diagram illustrating an example configuration of the non-AP STA 201 for managing low-latency communication in the communication network 205, according to various example embodiments. In an embodiment, the non-AP STA 201 may include an I/O interface (e.g., including circuitry) 303, a processor (e.g., including processing circuitry) 305 and a memory 307 storing instructions, executable by the processor 305, which, on execution, may cause the non-AP STA 201 to manage low-latency communication in the communication network 205. In an embodiment, the memory 307 may include data 309. Further, the non-AP STA 201 may also include a transceiver 310.

In an embodiment, the data 309 may include for example, but not limited to, first reconfiguration request message, first reconfiguration response message, second reconfiguration request message, and second reconfiguration response message. In an embodiment, without limiting, the data 309 may be dynamically updated based on real-time data received by the non-AP STA 201.

In an embodiment, the processor 305 may include various processing circuitry and be configured to select the target AP 203b from one or more candidate APs during a preparation phase of a roaming procedure. For example, the processor 305 may identify the one or more candidate APs configured to support low latency requirement for the non-AP STA 201, during a preparation phase of the roaming procedure. In an embodiment, the processor 305 may evaluate capability information of a set of nearby APs during a discovery phase of the roaming procedure, and filter the set of nearby APs, based on the evaluated capability information, to identify the one or more candidate APs. The processor 305 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 305 may further transmit the second reconfiguration request message based on the identified one or more candidate APs, to the source AP 203a, in which second reconfiguration request message comprises at least one of the roaming phase type indicating the preparation phase, a presence indicator for the target AP 203b identification, an Identifier (ID) of each of the one or more candidate APs indicating MAC address, and the QoS characteristics of the non-AP STA 201 comprising at least one of number of queued low latency packets, expiration time of the low latency packets, and QoS requirements of the low latency packets. Further, the processor 305 may receive the second reconfiguration response message from the source AP 203a, based on the transmitted second reconfiguration request message, in which the second reconfiguration response message comprises at least one of a Low Latency Indication (LLI) status of the one or more candidate APs. Further, the processor 305 may select the target AP 203b, from the one or more candidate APs, based on the received second reconfiguration response message. In an embodiment, the LLI status in the second reconfiguration response message comprises at least one of complete acceptance, partial acceptance or rejection of the QoS requirements sent in reconfiguration request. In an embodiment, the non-AP STA 201 may perform the steps of transmitting and receiving using the transceiver 310. That is, the transceiver 310 may receive the second reconfiguration request message from the processor 305, and transmit the second reconfiguration request message to the source AP 203a for further processing. Similarly, the transceiver 310 may receive the second reconfiguration response message from the source AP 203a, and transmit the second reconfiguration response to processor 305 for further processing.

In an embodiment, the processor 305 may be configured to transmit the first reconfiguration request message to the AP 203, during an execution phase of the roaming procedure, in which the first reconfiguration request message comprises at least one of a roaming phase type indicating the execution phase, an Identifier (ID) of the selected target AP 203b indicating Media Access Control (MAC) address, and Quality of Service (QoS) characteristics of the non-AP STA 201 comprising at least one of number of queued low latency packets, expiration time of the low latency packets, and Quality Of Service (QoS) requirements of the low latency packets. The AP 203 comprises one of the source AP 203a or the selected target AP 203b.

In an embodiment, the processor 305 may be configured to receive the first reconfiguration response message from the AP 203, based on the transmitted first reconfiguration request message, in which the first reconfiguration response message comprises at least a Down Link (DL) drain time of the selected target AP 203b. The DL drain time is set on the basis of QoS requirements indicated in the first reconfiguration request message. Further, the processor 305 may be configured to manage the low-latency communication in the communication network 205, based on the received first reconfiguration response message.

In an embodiment, the first reconfiguration request message is transmitted to the AP 203, and the first reconfiguration response message is received from the AP 203, during an execution phase of the roaming procedure.

In an embodiment, the processor 305 may prioritize uplink transmission of queued low-latency packets immediately after expiry of the DL drain time indicated in the first reconfiguration response message. Further, the processor 305 may manage the low-latency communication in the communication network, based on the prioritized uplink transmission.

Furthermore, the non-AP STA 201 may optionally include one or more modules (not shown in FIG. 3) for performing one or more operations performed by the processor 305. In an embodiment, each of the one or more modules may be a hardware unit/software module/firmware module which may be outside the memory 307 and coupled with the processor 305. In an embodiment, the one or more modules may be within the processor 305.

In an embodiment, the processor 305 may perform the above steps using the one or more modules. For example, the one or more modules may enable the processor 305 to perform the above recited steps of selecting the target AP 203b, transmitting the first reconfiguration request message to the AP 203, receiving the first reconfiguration response message from the AP 203, and managing the low-latency communication in the communication network 205.

In an embodiment, the first reconfiguration request message and the first reconfiguration response message correspond to execution phase of the roaming procedure, and the second reconfiguration request message and the second reconfiguration response message correspond to preparation phase of the roaming procedure.

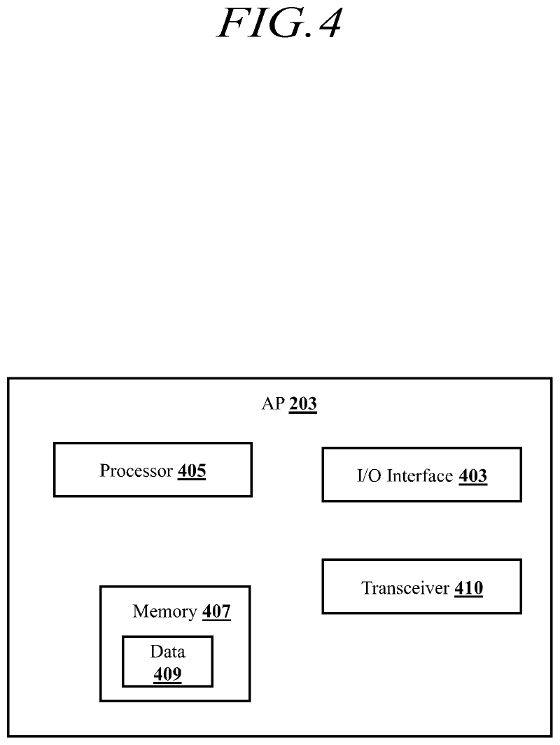

FIG. 4 is a block diagram illustrating an example configuration of the AP 203 for managing low-latency communication in a communication network, according to various example embodiments. In an embodiment, the AP 203 may include an I/O interface (e.g., including circuitry) 403, a processor (e.g., including processing circuitry) 405 and a memory 407 storing instructions, executable by the processor 405, which, on execution, may cause the AP 203 to manage low-latency communication in the communication network 205. In an embodiment, the memory 407 may include data 409. Further, the AP 203 may also include a transceiver 410.

In an embodiment, the data 409 may include for example, but not limited to, first reconfiguration request message, first reconfiguration response message, second reconfiguration request message, and second reconfiguration response message. In an embodiment, without limiting, the data 409 may be dynamically updated based on real-time data received by the AP 203.

In an embodiment, the processor 405 may be configured to receive the first reconfiguration request message from the non-AP STA 201, during an execution phase of the roaming procedure, in which the first reconfiguration request message comprises at least one of a roaming phase type indicating the execution phase, an Identifier (ID) of a selected target AP 203b indicating a Media Access Control (MAC) address, and a Quality of Service (QoS) characteristics of the non-AP STA 201 comprising at least one of number of queued low latency packets, expiration time of the low latency packets, and Quality Of Service (QoS) requirements of the low latency packets. The AP 203 includes one of the source AP 203a or the selected target AP 203b. In an embodiment, the block diagram of AP 203 may be individually applicable to the source AP 203a, and the target AP 203b. In an embodiment, the transceiver 410 may receive the first reconfiguration request message from the non-AP STA 201, and transmit the first reconfiguration request message to the processor 405 for further processing. The processor 405 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the processor 405 may be configured to transmit the first reconfiguration response message to the non-AP STA 201, based on the received first reconfiguration request message, to manage low-latency communication in the communication network, in which the first reconfiguration response message comprises a Down Link (DL) drain time of the selected target AP 203b. The DL drain time is set on the basis of QoS requirements indicated in the first reconfiguration request message.

For example, the processor 405 may determine completion of a context message transfer between the source AP 203a, and the selected target AP 203b, based on the first reconfiguration request message, in which the context message comprises parameters related to the non-AP STA 201. Further, the processor 405 may compute the DL drain time of the selected target AP 203b, based on the determined completion. Further, the processor 405 may generate the first reconfiguration response message, based on the computed DL time, and transmit the first reconfiguration response message to the non-AP STA 201. In an embodiment, the context message comprises a negotiation request message including a Low Latency Indication (LLI) support flag.

Furthermore, the AP 203 may optionally include one or more modules (not shown in FIG. 4) for performing one or more operations performed by the processor 405. In an embodiment, each of the one or more modules may be a hardware unit/software module/firmware module which may be outside the memory 407 and coupled with the processor 405. In an embodiment, the one or more modules may be within the processor 405.

In an embodiment, the processor 405 may perform the above steps using the one or more modules. For example, the one or more modules may enable the processor 405 to perform the above recited steps of receiving the first reconfiguration request message, and transmitting the first reconfiguration response message.

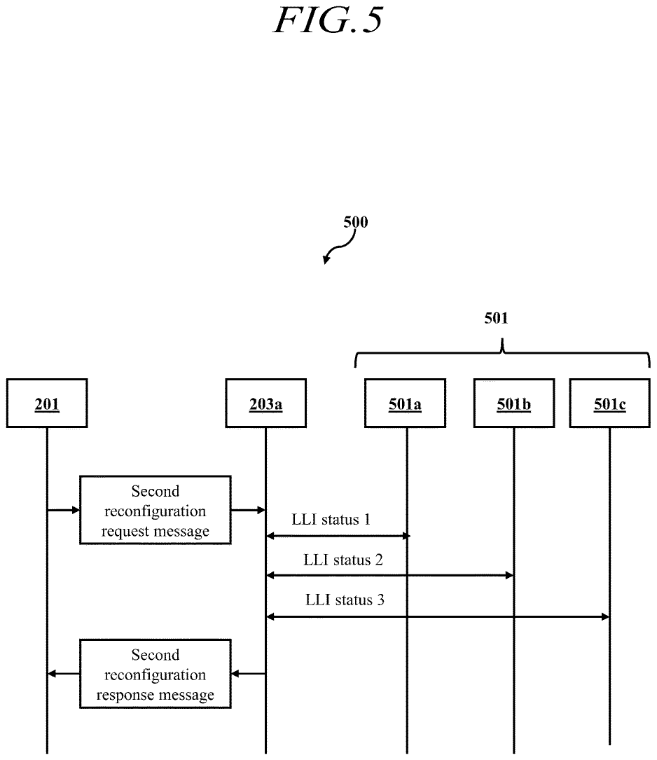

FIG. 5 is a signal flow diagram 500 illustrating example operations of selecting the target AP 203b, from the one or more candidate APs, according to various example embodiments. In an embodiment, the signal flow diagram 500 includes the non-AP STA 201, the source AP 203a, and one or more candidate APs 501. The non-AP STA 201 identifies the one or more candidate APs 501 configured to support low latency requirement for the non-AP STA 201. For example, the one or more candidate APs 501 may include a target AP1 501a, a target AP2 501b, and target AP3 501c. The target AP1 501a and the target AP2 501b supports the low latency requirement for the non-AP STA 201.

Further, the non-AP STA 201 transmits a second reconfiguration request message based on the identified one or more candidate APs 501, to the source AP 203a, in which the second reconfiguration request message comprises at least one of the roaming phase type indicating the preparation phase, a presence indicator for the target AP identification, an Identifier (ID) of each of the one or more candidate APs 501 indicating MAC address, and the QoS characteristics of the non-AP STA 201 comprising at least one of number of queued low latency packets, expiration time of the low latency packets, and QoS requirements of the low latency packets.

Further, the non-AP STA 201 receives the second reconfiguration response message from the source AP 203a, based on the transmitted second reconfiguration request message, in which the second reconfiguration response message comprises at least one of a Low Latency Indication (LLI) status of the one or more candidate APs 501. Further, the non-AP STA 201 may select the target AP 203b, from the one or more candidate APs 501, based on the received second reconfiguration response message. For example, based on the LLI status, the non-AP STA 201 may select the target AP1 501a as the target AP 203b.

During the Seamless Roaming preparation phase, the non-AP STA 201 may identify and prepare those candidate APs which support LLI to support the low latency requirements of the non-AP STA 201. The non-AP STA 201 may identify by Ultra High Reliability (UHR) Capabilities in the discovery phase whether the candidate APs can support low latency indication. Furthermore, the non-AP STA 201 can choose to prepare all those candidate APs that support LLI rather than those that do not support LLI. This will further improve the handling of low latency packets. Hence once the non-AP STA 201 decides to roam, the first reconfiguration request message is sent to the source AP 203a with Type set to Preparation. The first reconfiguration request message shall contain the Low Latency Indication Support field which can be set to value 1 or TRUE and sent to source AP 203a. For example, the Source AP 203a, transfers the context to the target AP1 501a. The context to be transferred shall contain Low Latency Indication Support (apart from other baseline context related information). The process is repeated with all the Target APs such as the target AP3 501c, that support low latency indication. Further in the Link Reconfiguration Response message received after the respective Target AP is prepared, the following information is included Profile: Low Latency Indication Status-Accepted complete, Accept partial, Rejected. For example, the source AP 203a may receive LLI status such as LLI status 1 from target AP1 501a, LLI status 2 from target AP2 501b, and LLI status 3 from target AP3 501c. In an embodiment, the process of transmitting second reconfiguration request message to the multiple APs and receiving of the LLI status from the multiple APs may be in parallel manner (as shown in FIG. 5) or in sequential manner.

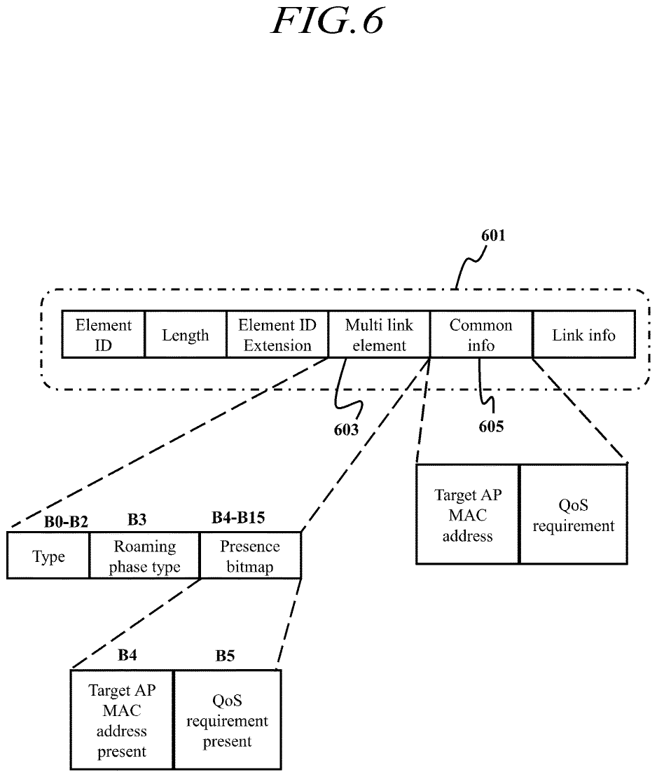

FIG. 6 is a diagram illustrating an example data format a second reconfiguration request message 601, according to various example embodiments. The second reconfiguration request message 601 comprises a Multi link element 603, which is a Protected Extremely High Throughput (EHT) Action Frame. The Action field of the second reconfiguration request message 601 contains the Multi link element 603. During Roaming preparation phase, the second reconfiguration request message 601 is used to set the QoS Requirement (e.g. Low Latency Indication) along with other baseline solutions that include type of Roaming phase as Preparation and Target AP MAC address included for which the non-AP STA 201 wants to prepare for Seamless Roaming.

The Multi link element 603 includes a reserved bit B3 repurposed to indicate whether the Roaming phase is preparation or execution. For example, Roaming Phase Type 0 indicates Preparation phase, and Roaming Phase Type 1 indicates Execution phase. Further, the Multi link element may include a presence bitmap, enhanced to further include Bit 4 indicating whether Target AP MAC ID/Address is present, and Bit 5 indicating whether QoS Requirement is present.

Further, a common info 605 of the second reconfiguration request message 601 includes the Target AP MAC ID/Address indicating the Identifier and/or Address (e.g. MAC Address) of the Target AP 203b. Further, the common info 605 includes QoS requirement indicating various QoS or special requirements that the Non-AP STA 201 wishes to prioritize. The value of QoS requirement is as shown in Table 3:

TABLE 3

| Value | Name |
|---|---|
| 1 | Low latency indication present |
| 0, 2 to 31 | Reserved (for future use) |

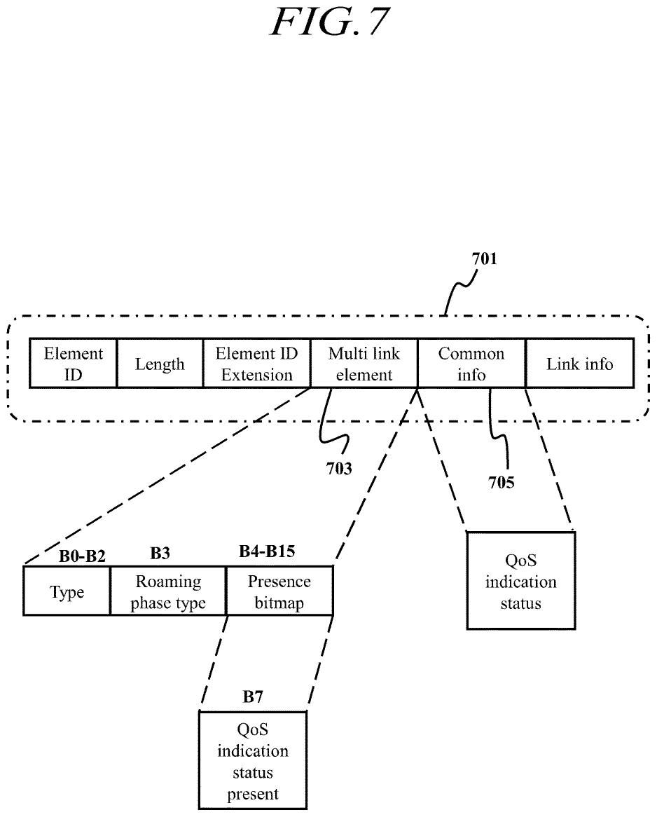

FIG. 7 is a diagram illustrating an example data format of the second reconfiguration response message 701, according to various example embodiments. The second reconfiguration response message 701 is a Protected EHT Action Frame. The Action field the second reconfiguration response message contains a Multi link element 703. During roaming preparation phase, the second reconfiguration response message is used to set the Profile for

Low Latency Indication Status along with other baseline solutions that include success or failure of the associated first reconfiguration request message.

The Multi link element 703 includes a reserved bit B3 that can be repurposed to indicate whether the Roaming phase type is preparation or execution. For example, roaming phase type 0 indicate preparation phase, and roaming phase type 1 indicates execution phase. Further, the Multi link element includes a Presence bitmap of bits B4-B15, containing Bit 7 indicating whether QoS Indication Status is present. Further, a common info 705 of the second reconfiguration response message 701 includes a QoS indication status, and is present if the Bit 7 is indicated as present in Multi link element 703.

The value of QoS Indication Status is as shown in below Table 4:

TABLE 4

| Value | Status |
|---|---|
| 1 | QoS indication status accepted |
| 2 | QoS indication status rejected |
| 3 | QoS indication status partially accepted |
| 0, 4 to 31 | Reserved for future use |

A complete accept may refer, for example, to the low latency indication being fully supported by the target AP 203b, while a partial accept may refer, for example, to the Target AP 203b being ready to accept the roaming transition, but cannot guarantee QoS indication and a complete reject indicates that the target AP 203b is not ready to accept the non-AP STA 201 with the QoS requirements at all.

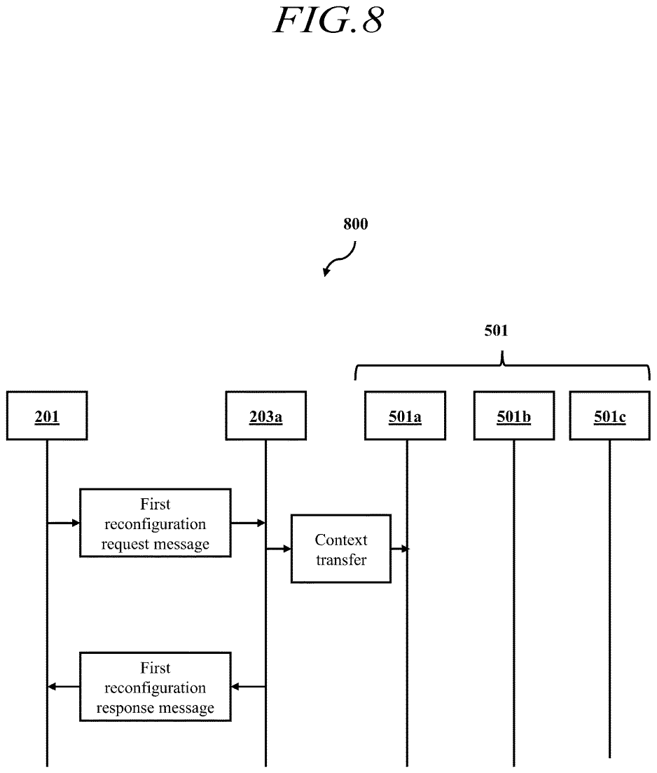

FIG. 8 is a signal flow diagram 800 illustrating example operations of managing low-latency communication in the communication network 205, according to various example embodiments. During the Seamless Roaming execution procedure, the non-AP STA 201 stops sending all Uplink Data and sends a first reconfiguration request message to the source AP 203a with type set to execution. Along with the baseline requirements of sending Execution type, Low latency Delay Report may be included. The contents of low latency delay report may include the number of MSDU/MPDU with low latency requirements, the expiration time of the MSDU or MPDU including lowest, average and highest values. Further context Transfer is done between source AP 203a and the target AP 203b identified in the first reconfiguration request message. For example, if the target AP 203b corresponds to target AP1 501a, the source AP 203a transfers context to the target AP1 501a. The Source AP 203a responds with the first reconfiguration response message after context transfer is completed and includes a result of success or failure, including DL Drain Time. The DL drain time corresponds to the time for which the DL Data will be delivered to the non-AP STA 201 via the source AP 203a.

With reference to FIG. 8, the source AP 203a may set the DL Drain Time using the Low Latency Delay Report. The source AP 203a may consider the lowest (or average or highest) expiration time of the low latency delay report and set the DL Drain time to a value lesser than the expiration time and ensure that the uplink data packets gets sufficient time to be sent to Target AP 203b. The Target AP 203b, which is also aware of the expiration times in low latency delay report, immediately triggers uplink packets first and then transfer the remaining DL packets.

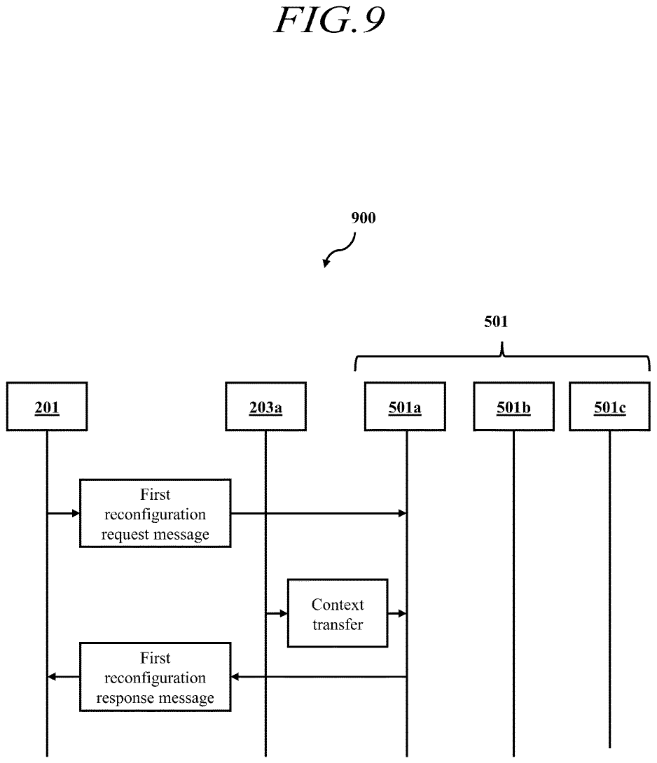

FIG. 9 is a signal flow diagram 900 illustrating example operations of managing low-latency communication in the communication network 205, according to various example embodiments.

During the seamless roaming execution procedure, the non-AP STA 201 stops sending all Uplink Data and sends a first reconfiguration request message to the target AP 203b such as the target AP1 501a, with type set to execution. Along with the baseline requirements of sending Execution type, Low latency Delay Report may be included. The contents of low latency delay report may be the expiration time of the MSDU or MPDU. Further Context Transfer is done between source AP 203a and the target AP1 501a.

The Target AP1 501a responds with a first reconfiguration response message after context transfer is completed and the first reconfiguration response message includes a result of success or failure, and DL drain Time. The DL drain time is the time for which the DL Data will be delivered to the non-AP STA 201 via the source AP 203a. With reference to FIG. 9, the target AP 203b such as the target AP1 501a may set the DL drain time using the Low Latency Delay Report. The target AP1 501a, also aware of the expiration times in low latency delay report, immediately trigger uplink packets first and then transfer the remaining DL packets.

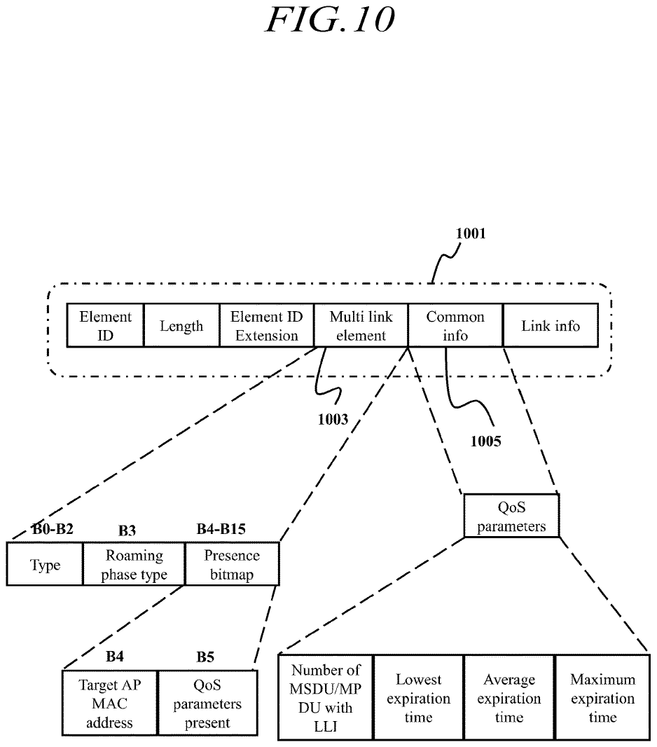

FIG. 10 is a diagram illustrating an example data format of a first reconfiguration request message 1001, according to various example embodiments. The first reconfiguration request message 1001 is a protected EHT Action Frame. The Action field of the first reconfiguration request message 1001 contains a Multi link element 1003.

During roaming execution phase, the first reconfiguration request message 1001 is used to set the QoS Parameters (e.g. Low Latency Delay Report) along with other baseline solutions that include type of Roaming phase as execution and Target MLD MAC address included for which the non-AP STA 201 wants to prepare for Seamless Roaming. The Multi link element 1003 includes a reserved bit B3 repurposed to indicate whether the Roaming phase is preparation or execution. For example, Roaming Phase Type 0 can indicate Preparation phase, and Roaming Phase Type 1 can indicate Execution phase. Further, the Multi link element comprises a presence bitmap enhanced to further include Bit 4 indicating whether Target AP ID/Address is present, and Bit 5 indicating whether QoS Parameters is present.

The target AP ID/Address indicates the Identifier and/or Address (e.g. MAC Address) of the Target AP 203b. Further, a common info 1005 of the first reconfiguration request message 1001 includes QoS parameters indicating various QoS or special requirements that the Non-AP STA 201 wishes to prioritize. The QoS parameters includes the number of MSDU or MPDUs that are in the queue with a low latency requirement, and the Expiration time indicators such as the lowest expiration time, average expiration time, and maximum expiration time. The Expiration time may be an expression of lowest expiration time or earliest expiration time and then with highest expiration time or latest expiration time of the packets. Further an average expiration time can also be included.

In an embodiment, the context transfer may include:
block ack parameters and block ack timeout value for any block ack agreement on each TID.
The next SN to be assigned for DL individually addressed data frame of each TID.
The latest duplicate receiver cache for each TID without block ack agreement.
The latest SN that has been passed up for each TID with UL block ack agreement.
The starting PN to be assigned for DL individually addressed frame by the target AP 203b.
The initial value to be used by each replay counter of the target AP 203b for UL individually addressed frame.
WinStartO of each existing DL block ack agreement.

Further, the context transfer may also include:
The QoS Requirement indicator value (e.g. Low Latency Indicator value)
The Associated QoS Requirement parameters (e.g: Low Latency Delay Report)
The expression of the low latency delay report can include the lowest, average and highest expiration time including the number of MSDUs in the queue with low latency requirement.

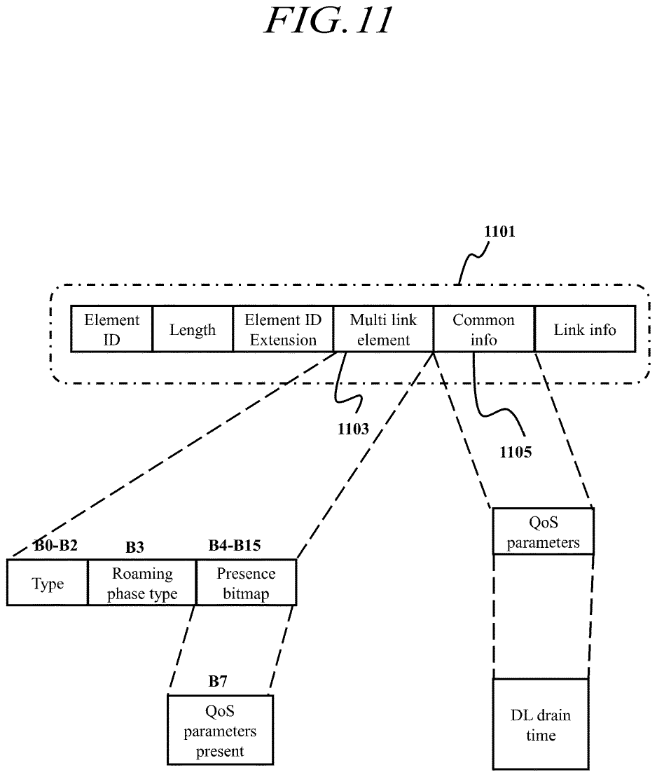

FIG. 11 is a diagram illustrating an example data format of first reconfiguration response message 1101, according to various example embodiments. The first reconfiguration response message 1101 is a protected EHT Action Frame. The Action field of the first reconfiguration response message 1101 contains a Multi link element 1103. During Roaming execution phase, the first reconfiguration response message is used to set the Profile for Low Latency Indication Status along with other baseline solutions that include success or failure of the associated first reconfiguration request message 1001.

The Multi link element 1103 includes a reserved bit B3, repurposed to indicate whether the Roaming phase is preparation or execution. For example, Roaming Phase Type 0 indicates Preparation phase, and Roaming Phase Type 1 indicates Execution phase. Further, the Multi link element 1103 includes a presence bitmap enhanced to further include Bit 7 indicating whether QoS Parameters is present. Further, a common info 1105 of the first reconfiguration response message 1101 includes QoS parameters further including DL Drain Time. The DL drain time basically allows a certain period of time until which the DL Data can be sent to the non-AP STA 201 from the source AP 203a after Roaming execution phase has started. The DL Drain time is set on the basis of the Expiration times sent in first reconfiguration request message 1001 during execution phase. The source AP MLD may set up a small time for DL Drain time which is lesser than the least value of Expiration time as an example and help the low latency packets in the queue during a roaming phase.

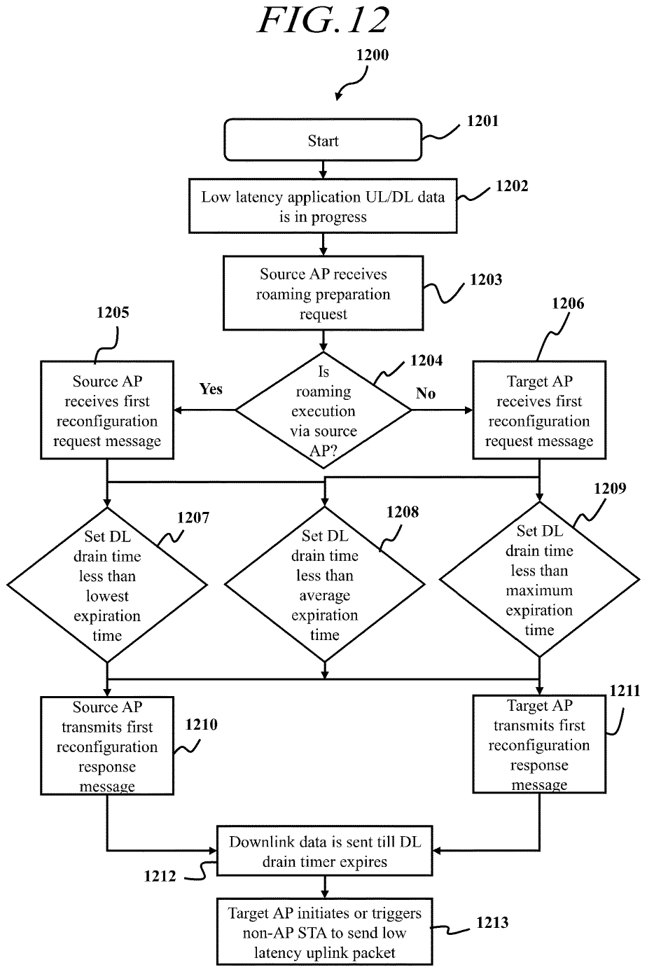

FIG. 12 is a flowchart 1200 illustrating an example operation of setting DL drain time, according to various example embodiments. At block 1201, the non-AP STA 201 detects that roaming is required, and the DL Drain Time decision process begins. At block 1202, the non-AP STA 201 and the source AP 203a are actively exchanging real-time, low-latency traffic packets having strict expiration times. Block 1203 occurs during the Seamless Roaming Preparation Phase, after the non-AP STA 201 has decided that roaming may be required. For example, the source AP 203a receives the second reconfiguration request message (Type=Preparation), which includes low-latency requirements, and the source AP 203a now begins preparing the appropriate Target AP 203b by transferring context and verifying ability to support Low Latency Indication.

Block 1204 checks whether the non-AP MLD is performing roaming execution using the source AP 203a. If Yes, the source AP 203a receives first reconfiguration request message, as shown in block 1205. If No, the target AP 203b receives first reconfiguration request message containing the low latency delay report, as shown in block 1206. The source AP 203a or the target 203b may analyse the low latency delay report and may set the DL drain time less than lowest expiration time (as shown in block 1207)/average expiration time (as shown in block 1208)/maximum expiration time (as shown in block 1209). Further, at block 1210, the source AP 203a transmits, to the non-AP STA 201, the first reconfiguration response message, with DL drain timer set. Further, at block 1211 the target AP 203b transmits, to the non-AP STA 201, the first reconfiguration response message, with DL drain timer set. At block 1212, the source AP 203a continues delivering all remaining DL packets to the non-AP STA 201 until the DL Drain Time (calculated from packet expiration values) runs out. This prevents and/or reduces DL packet loss while ensuring the system switches to uplink quickly enough to protect UL low-latency packets from expiration. At block 1213, once the DL Drain Time has expired, the Target AP 203b immediately triggers the non-AP STA 201 to send uplink low-latency traffic. This prevents and/or reduces packet expiration and ensures the non-AP STA 201 resumes uplink transmission at the earliest possible moment after roaming execution.

Consider an example where the non-AP STA 201 observes a rapid drop in Received Signal Strength Indicator (RSSI) from the source AP 203a, and increase in latency for XR packets. The non-AP STA 201 decides roaming is needed, so the DL Drain Time decision process starts. The non-AP STA 201 sends UL XR tracking packets every 2 ms. The AP 203 sends DL XR frames every 4 ms. These packets have expiration timers (6-12 ms), so timing is critical. The non-AP STA 201 sends, to the source AP 203a, a Link Reconfiguration Request (Type=Preparation), LLI=TRUE. The source AP 203a receives the request, and begins preparing target AP 203b. Target AP 203b confirms “I support low latency indication (LLI)”, and sends LLI acceptance status back. If roaming execution is via source AP 203a, the non-AP STA 201 sends the Execution-Phase Reconfiguration Request to Source AP 203a, with Link Reconfiguration Request (Type=Execution), and Low Latency Delay Report containing:
Number of Packets=3
min expiration=6 ms
avg expiration=9.3 ms
max expiration=12 ms

Source AP 203a receives the low latency delay report, and sets DL Drain Time. Assume the source AP 203a chooses DL Drain Time of less than lowest expiration time. For example, Lowest expiration=6 ms→Source AP 203a picks DL Drain Time=5 ms. This ensures the source AP 203a stops DL before packet (6 ms) expires. The non-AP STA 201 gets UL opportunity before any UL packet expires. The source AP 203a sends Link Reconfiguration Response with DL_Drain_Time=5 ms, and Result=SUCCESS. The non-AP STA 201 now knows of receiving DL for 5 ms. After the DL drain time expires, UL will be triggered by the target AP 203b.

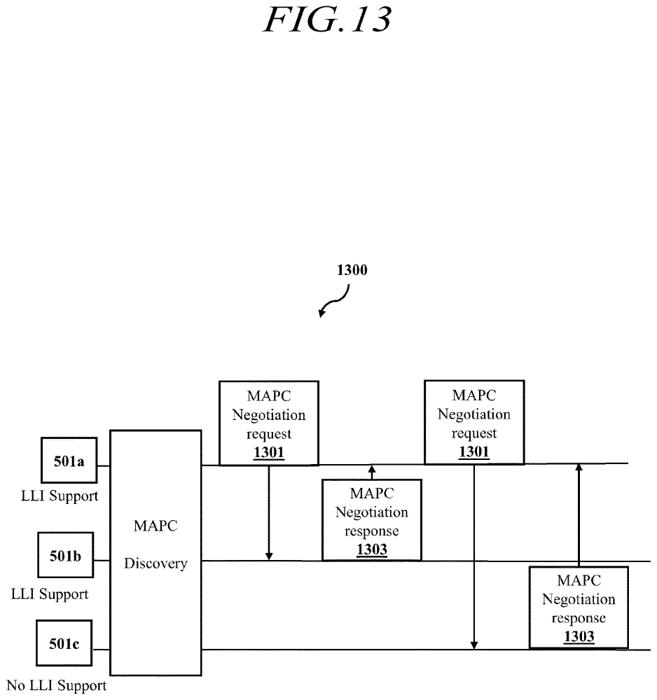

FIG. 13 is a signal flow diagram 1300 illustrating example operations of managing low-latency communication in a communication network, according to various example embodiments.

In an embodiment, the AP 203 may transmit a negotiation request message to one or more candidate co-ordinated APs, in which the AP 203 is a co-ordinating AP, and the negotiation request message comprises a Low Latency Indication (LLI) support flag. Further, the AP 203 may receive requirements related to QoS characteristics from the one or more candidate co-ordinated APs, based on the transmitted negotiation request message, in which the QoS characteristics correspond to latency requirements of respective non-AP STA 201 associated with each of the one or more candidate co-ordinated APs. The QoS characteristics comprises number of queued low latency packets, expiration time of the low latency packets, and Quality Of Service (QoS) requirements of the low latency packets including traffic flows and associated minimum and maximum service times. Further, the AP 203 may transmit one or more allocation resources to each of the one or more candidate co-ordinated APs, based on the received requirements related to the QoS characteristics, for managing low-latency communication in a communication network.

In a Multi-AP (M-AP) co-ordination scheme, multiple APs such as target AP1 501a, target AP2 501b, and target AP3 501c may coordinate to share time resources in schemes such as C-TDMA. During the MAP-C discovery procedure, the multiple APs discover the M-AP co-ordination features that each AP supports and then moves to the negotiation phase where the profile and schemes of particular feature are exchanged. MAPC Negotiation Request and MAPC Negotiation Response messages shall carry the QoS Requirement support (e.g Low Latency Indication Support) to indicate that the multiple APs and respective non-AP STA(s) have low latency indication support and further co-ordination shall take into account the low latency indication support as well.

Let us consider an example of a Multi-AP Coordination (MAPC) environment where three APs (target AP1 501a, target AP2 501b, and target AP3 501c) operate in a coordinated network to support low-latency applications such as XR, cloud gaming, robotics, etc. In this example:
Target AP1 501a→Supports Low Latency Indication (LLI)
Target AP2 501b→Supports Low Latency Indication (LLI)
Target AP3 501c→Does NOT support LLI

APs discover each other's coordination capabilities. Target AP1 501a checks which nearby APs can cooperate for coordinated time scheduling, such as Co-TDMA, C-RTWT, or other MAPC schemes.
Target AP1 501a discovers target AP2 501b→supports LLI
Target AP1 discovers target AP3 501c→does not support LLI
This phase helps AP1 know which APs can assist in low-latency scheduling.

Target AP1 501a begins MAPC negotiation by sending a MAPC Negotiation Request 1301 to target AP2 501b and target AP3 501c. Each request includes the Low Latency Indication Support bit inside the Additional Capabilities field of the MAPC element. The MAPC Negotiation Request includes:
Additional Capability: LLI-Support=1

Target AP2 501b replies with:
MAPC Negotiation Response 1303: LLI-Support=1

Target AP3 501c replies with:
MAPC Negotiation Response 1303: LLI-Support=0

Target AP1 501a builds Low-Latency Coordination Set, based on the received responses. In Co-TDMA scheme, after the MAPC negotiation phase, the polling phase includes transmission of an ICF-ICR sequence between the polling AP and polled AP(s). The ICR carries a Low Latency Delay report that includes the expiration times of the MSDUs with low latency requirements. The expression of the expiration time may be lowest expiration time, average expiration time and/or maximum expiration time. The target AP1 501a may have visibility of expiration times and may schedule the target AP2 501b before the target AP3 501c to facilitate low latency packet expiry at target AP2 501b.

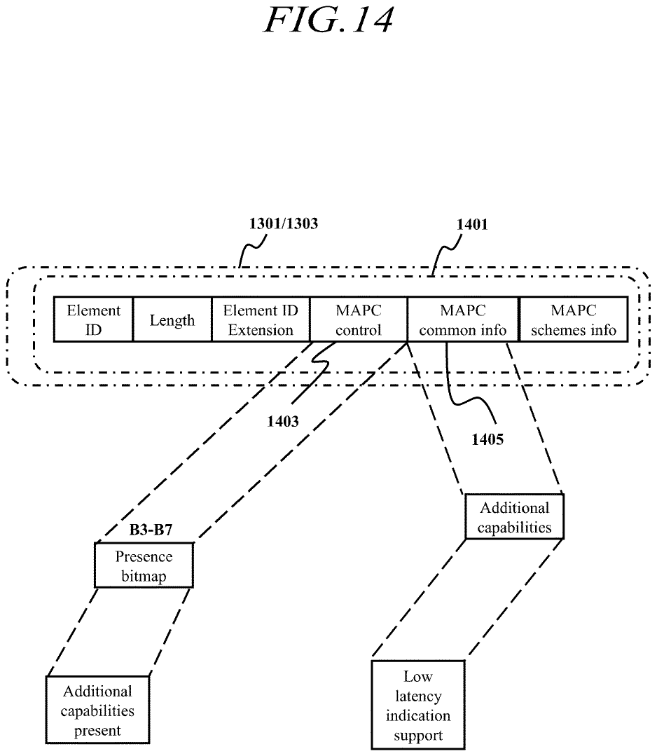

FIG. 14 is a diagram illustrating an example data format of the MAPC negotiation request 1301/MAPC negotiation response 1303, according to various example embodiments. In an embodiment, the MAPC negotiation request 1301/MAPC negotiation response 1303 are Public UHR Action Frames. The MAPC Negotiation Info within MAPC negotiation request 1301/MAPC negotiation response contains a MAPC element 1401 as shown in FIG. 14. During MAPC Negotiation Phase, the MAPC negotiation request 1301 is sent to negotiate the MAPC parameters for particular co-ordination schemes in consideration. In response the co-ordinated AP(s) respond with MAPC negotiation response 1303.

The MAPC element 1401 includes a MAPC control 1403 includes a presence bitmap enhanced to further include Bit 4 indicating whether Additional Capabilities field is present. Further, a MAPC Common Info 1405 of the MAPC element 1401 includes Additional Capabilities Information and the presence bit is set accordingly. The additional capabilities may include any capabilities that the AP 203 wishes to exchange between co-ordinated APs. A one bit indicator is defined to indicate that the AP 203 and at least one of respective non-AP STA 201 support the low latency indicator support and wishes to communicate the same with other AP(s). Hence during negotiation phase, the MAPC element 1401 may include capability and when a co-ordinating AP is sending request, the Additional Capabilities may be included in the MAPC common info 1405. Similarly the responding AP(s) may include the MAPC Common Info with Additional Capabilities such as Low Latency Indication Support to indicate that the AP and respective STAs support the same.

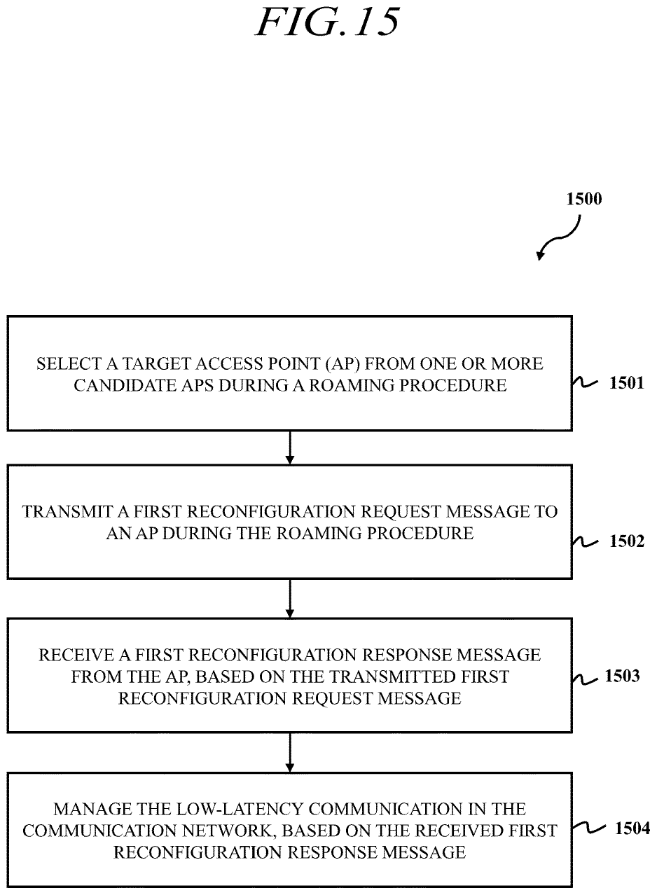

FIG. 15 is a flowchart illustrating an example method 1500 for managing low-latency communication in a communication network, according to various example embodiments.

At step 1501, the method 1500 includes selecting, by the non-AP STA 201, the target AP 203b from one or more candidate APs during a roaming procedure. For example, the method 1500 includes identifying, by the non-AP STA 201, the one or more candidate APs configured to support low latency requirement for the non-AP STA, during a preparation phase of the roaming procedure. Further, the method 1500 includes transmitting, by the non-AP STA 201, a second reconfiguration request message 601 based on the identified one or more candidate APs, to the source AP 203a, in which the second reconfiguration request message 601 comprises at least one of the roaming phase type indicating the preparation phase, a presence indicator for the target AP 203b identification, an Identifier (ID) of each of the one or more candidate APs indicating MAC address, and the QoS characteristics of the non-AP STA 201 comprising at least one of number of queued low latency packets, expiration time of the low latency packets, and QoS requirements of the low latency packets. Further, the method 1500 includes receiving, by the non-AP STA 201, the second reconfiguration response message 701 from the source AP 203a, based on the transmitted second reconfiguration request message 601, in which the second reconfiguration response message 701 comprises at least one of a Low Latency Indication (LLI) status of the one or more candidate APs. Furthermore, the method 1500 includes selecting, by the non-AP STA 201, the target AP 203b, from the one or more candidate APs, based on the received second reconfiguration response message 701.

At step 1502, the method 1500 includes transmitting, by the non-AP STA 201, the reconfiguration request message 1001 to the AP 203, during the roaming procedure, in which the first reconfiguration request message 1001 comprises at least one of a roaming phase type indicating the execution phase, an Identifier (ID) of the selected target AP 203b Media Access Control (MAC) address, and Quality of Service (QoS) characteristics of the non-AP STA 201 comprising at least one of number of queued low latency packets, expiration time of the low latency packets, and Quality Of Service (QoS) requirements of the low latency packets.

At step 1503, the method 1500 includes receiving, by the non-AP STA 201, the first reconfiguration response message 1101 from the AP 203, based on the transmitted first reconfiguration request message 1001, in which the first reconfiguration response message 1101 comprises at least a Down Link (DL) drain time of the selected target AP 203.

At step 1504, the method 1500 includes managing, by the non-AP STA 201, the low-latency communication in the communication network 205, based on the received first reconfiguration response message 1101.

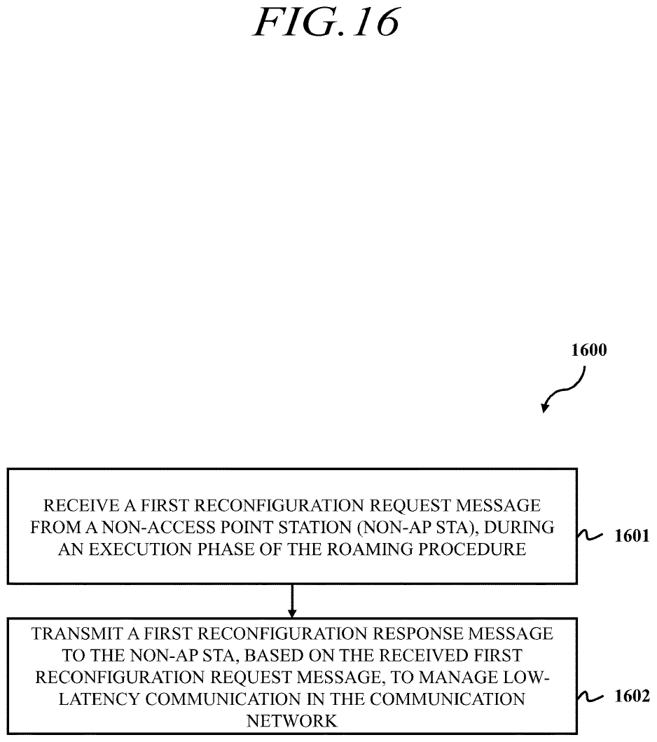

FIG. 16 is a flowchart illustrating an example method 1600 for managing low-latency communication in the communication network 205, according to various example embodiments.

At step 1601, the method 1600 includes receiving, by the AP 203, the first reconfiguration request message 1001 from the non-AP STA 201, during an execution phase of the roaming procedure, in which the first reconfiguration request message 1001 comprises at least one of a roaming phase type indicating the execution phase, an Identifier (ID) of a selected target AP 203b indicating a Media Access Control (MAC) address, and a Quality of Service (QoS) characteristics of the non-AP STA 201 comprising at least one of number of queued low latency packets, expiration time of the low latency packets, and Quality Of Service (QoS) requirements of the low latency packets.

At step 1602, the method includes transmitting, by the AP 203, the first reconfiguration response message 1101 to the non-AP STA 201, based on the received first reconfiguration request message 1001, to manage low-latency communication in the communication network 205, in which the first reconfiguration response message 1101 comprises a Down Link (DL) drain time of the selected target AP 203b. For example, the method 1600 includes determining, by the AP 203, completion of a context message transfer between the source AP 203a, and the selected target AP 203b, based on the first reconfiguration request message 1001, in which the context message comprises parameters related to the non-AP STA 201. Further, the method 1600 includes computing, by the AP 203, the DL drain time of the selected target AP 203b, based on the determined completion. Further, the method 1600 includes generating, by the AP 203, the first reconfiguration response message 1101, based on the computed DL time. Furthermore, the method 1600 includes transmitting, by the AP 203, the first reconfiguration response message 1101 to the non-AP STA 201.

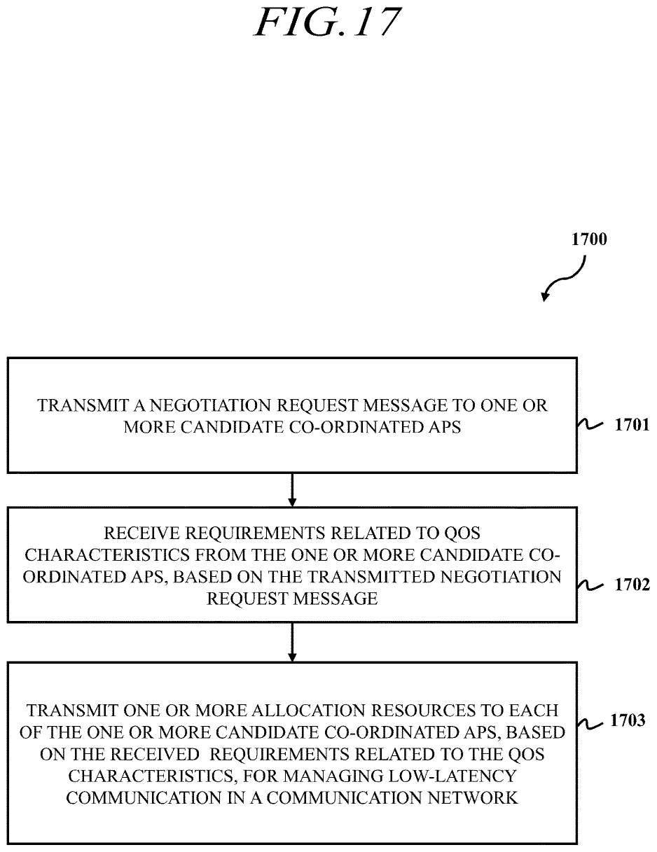

FIG. 17 is a flowchart illustrating an example method 1700 for managing low-latency communication in a communication network, according to various example embodiments.

At step 1701, the method 1700 includes transmitting, by the AP 203, a negotiation request message to one or more candidate co-ordinated APs, in which the AP 203 is a co-ordinating AP, and the negotiation request message comprises a Low Latency Indication (LLI) support flag.

At step 1702, the method 1700 includes receiving, by the AP 203, requirements related to QoS characteristics from the one or more candidate co-ordinated APs, based on the transmitted negotiation request message, in which the QoS characteristics correspond to latency requirements of respective non-AP STA 201 associated with each of the one or more candidate co-ordinated APs. The QoS characteristics comprises number of queued low latency packets, expiration time of the low latency packets, and Quality Of Service (QoS) requirements of the low latency packets including traffic flows and associated minimum and maximum service times.

At step 1703, the method 1700 includes transmitting, by the AP 203, one or more allocation resources to each of the one or more candidate co-ordinated APs, based on the received requirements related to the QoS characteristics, for managing low-latency communication in the communication network 205. For example, the method 1700 includes prioritizing, by the AP 203, the one or more candidate co-ordinated APs, based on the QoS characteristics corresponding to each of the one or more candidate co-ordinated APs. Further, the method 1700 includes transmitting, by the AP 203, the one or more allocation resources to each of the one or more candidate co-ordinated APs, based on the prioritization. In an embodiment, the QoS characteristics is carried in Multi-Access Point Coordination (MAPC) Negotiation procedure in a MAPC element and in the Polling and Transmission Opportunity (TXOP) allocation phase in Initial Control Response frame.

The methods 1500, 1600 and 1700 define a low-latency indication and reporting framework that works not only between non-AP STA and AP, but also during Seamless Roaming and Multi-AP coordination (Co-TDMA). By introducing Low Latency Delay Report (with expiration times), and DL Drain Time computation at AP MLDs, the methods 1500, 1600 and 1700 allow APs to schedule traffic intelligently, preventing and/or reducing expiration of MSDUs/MPDUs and reducing packet loss. The methods 1500, 1600 and 1700 allow target APs to be aware of expiration times, and immediately trigger uplink low-latency traffic after roaming, improving responsiveness and synchronisation.

In a method of managing low-latency communication in a communication network according to one embodiment, the method may comprise: selecting, by a non-Access Point station (non-AP STA), a target Access Point (AP) from one or more candidate APs during a roaming procedure; transmitting, by the non-AP STA, a first reconfiguration request message to the AP, during the roaming procedure, wherein the first reconfiguration request message comprises at least one of: a roaming phase type; an Identifier (ID) of the selected target AP indicating Media Access Control (MAC) address; or Quality of Service (QoS) characteristics of the non-AP STA comprising at least one of: a number of queued low latency packets; expiration time of the low latency packets; or Quality Of Service (QoS) requirements of the low latency packets, wherein the AP comprises one of a source AP or the selected target AP; receiving, by the non-AP STA, a first reconfiguration response message from the AP, based on the transmitted first reconfiguration request message, wherein the first reconfiguration response message comprises at least a Down Link (DL) drain time of the selected target AP, wherein the DL drain time is set based on QoS requirements indicated in the first reconfiguration request message; and managing, by the non-AP STA, the low-latency communication in the communication network, based on the received first reconfiguration response message.

In one embodiment, selecting the target AP from the one or more candidate APs during the roaming procedure, may comprise: identifying, by the non-AP STA, the one or more candidate APs configured to support low latency requirement for the non-AP STA, during a preparation phase of the roaming procedure; transmitting, by the non-AP STA, a second reconfiguration request message based on the identified one or more candidate APs, to the source AP, wherein the second reconfiguration request message comprises at least one of the roaming phase type indicating the preparation phase, a presence indicator for the target AP identification, an Identifier (ID) of each of the one or more candidate APs indicating MAC address, and the QoS characteristics of the non-AP STA comprising at least one of number of queued low latency packets, expiration time of the low latency packets, and QoS requirements of the low latency packets; receiving, by the non-AP STA, a second reconfiguration response message from the source AP, based on the transmitted second reconfiguration request message, wherein the second reconfiguration response message comprises at least one of a Low Latency Indication (LLI) status of the one or more candidate APs; and selecting, by the non-AP STA, the target AP, from the one or more candidate APs, based on the received second reconfiguration response message.

In one embodiment, identifying the one or more candidate APs, may comprise: evaluating, by the non-AP STA, capability information of a set of nearby APs during a discovery phase of the roaming procedure; and filtering, by the non-AP STA, the set of nearby APs, based on the evaluated capability information, to identify the one or more candidate APs.

In one embodiment, the LLI status in the second reconfiguration response message may comprise at least one of complete acceptance, partial acceptance and/or rejection of the QoS requirements sent in reconfiguration request.

In one embodiment, the first reconfiguration request message may be transmitted to the AP, and the first reconfiguration response message is received from the AP, during an execution phase of the roaming procedure.

In one embodiment, managing the low-latency communication in the communication network, may comprise: prioritizing, by the non-AP STA, uplink transmission of queued low-latency packets immediately after expiry of the DL drain time indicated in the first reconfiguration response message; and managing the low-latency communication in the communication network, based on the prioritized uplink transmission.

In one embodiment, managing the low-latency communication in the communication network, may comprise: prioritizing, by the non-AP STA, uplink transmission of queued low-latency packets after expiry of the DL drain time indicated in the first reconfiguration response message; and managing the low-latency communication in the communication network, based on the prioritized uplink transmission.

In a method of managing low-latency communication in a communication network according to one embodiment, the method may comprise: receiving, by an Access Point (AP), a first reconfiguration request message from a non-Access Point station (non-AP STA), during an execution phase of the roaming procedure, wherein the first reconfiguration request message comprises at least one of a roaming phase type indicating the execution phase, an Identifier (ID) of a selected target AP indicating a Media Access Control (MAC) address, and a Quality of Service (QoS) characteristics of the non-AP STA comprising at least one of number of queued low latency packets, expiration time of the low latency packets, and Quality Of Service (QoS) requirements of the low latency packets, wherein the AP includes one of a source AP or the selected target AP; and transmitting, by the AP, a first reconfiguration response message to the non-AP STA, based on the received first reconfiguration request message, to manage low-latency communication in the communication network, wherein the first reconfiguration response message comprises a Down Link (DL) drain time of the selected target AP, wherein the DL drain time is set based on QoS requirements indicated in the first reconfiguration request message.

In one embodiment, transmitting the first reconfiguration response message to the non-AP STA, may comprise: determining, by the AP, completion of a context message transfer between the source AP, and the selected target AP, based on the first reconfiguration request message, wherein the context message comprises parameters related to the non-AP STA;

computing, by the AP, the DL drain time of the selected target AP, based on the determined completion; generating, by the AP, the first reconfiguration response message, based on the computed DL time; and transmitting, by the AP, the first reconfiguration response message to the non-AP STA.

In one embodiment, the context message may comprise a negotiation request message including a Low Latency Indication (LLI) support flag.

In a method of managing low-latency communication in a communication network according to one embodiment, the method may comprise: transmitting, by an Access Point (AP), a negotiation request message to one or more candidate coordinated APs, wherein the AP is a coordinating AP, and wherein the negotiation request message comprises a Low Latency Indication (LLI) support flag; receiving, by the AP, requirements related to QoS characteristics from the one or more candidate co-ordinated APs, based on the transmitted negotiation request message, wherein the QoS characteristics correspond to latency requirements of respective non-AP STA associated with each of the one or more candidate co-ordinated APs, and wherein the QoS characteristics comprises number of queued low latency packets, expiration time of the low latency packets, and Quality Of Service (QoS) requirements of the low latency packets including traffic flows and associated minimum and maximum service times; and transmitting, by the AP, one or more allocation resources to each of the one or more candidate co-ordinated APs, based on the received requirements related to the QoS characteristics, for managing low-latency communication in a communication network.

In one embodiment, transmitting the one or more allocation resources to each of the one or more candidate APs, may comprise: prioritizing, by the AP, the one or more candidate co-ordinated APs, based on the QoS characteristics corresponding to each of the one or more candidate co-ordinated APs; and transmitting, by the AP, the one or more allocation resources to each of the one or more candidate co-ordinated APs, based on the prioritization.

In one embodiment, the QoS characteristics may be carried in Multi-Access Point Coordination (MAPC) Negotiation procedure in a MAPC element and in the Polling and Transmission Opportunity (TXOP) allocation phase in Initial Control Response frame.

In a non-Access Point station (non-AP STA) for managing low-latency communication in a communication network according to one embodiment, the non-AP STA may comprise: at least one processor comprising processing circuitry; and memory coupled with at least one processor, wherein at least one processor, individually or in any combination is configured to cause the non-AP STA to: select a target Access Point (AP) from one or more candidate APs during a roaming procedure; transmit a first reconfiguration request message to the AP, during the roaming procedure, wherein the first reconfiguration request message comprises at least one of: a roaming phase type; an Identifier (ID) of the selected target AP indicating Media Access Control (MAC) address; or a Quality of Service (QoS) characteristics of the non-AP STA comprising at least one of: a number of queued low latency packets; expiration time of the low latency packets; or Quality Of Service (QoS) requirements of the low latency packets, wherein the AP comprises one of a source AP or the selected target AP; receive a first reconfiguration response message from the AP, based on the transmitted first reconfiguration request message, wherein the first reconfiguration response message comprises at least a Down Link (DL) drain time of the selected target AP, wherein the DL drain time is set based on QoS requirements indicated in the first reconfiguration request message; and manage the low-latency communication in the communication network, based on the received first reconfiguration response message.

In an Access Point (AP) for managing low-latency communication in a communication network according to one embodiment, the AP may comprise: at least one processor comprising processing circuitry; and a memory coupled with at least one processor, wherein at least one processor, individually or in any combination, is configured to cause the AP to: receive a first reconfiguration request message from a non-Access Point station (non-AP STA), during an execution phase of the roaming procedure, wherein the first reconfiguration request message comprises at least one of: a roaming phase type indicating the execution phase; an Identifier (ID) of a selected target AP indicating a Media Access Control (MAC) address; or a Quality of Service (QoS) characteristics of the non-AP STA comprising at least one of: a number of queued low latency packets; expiration time of the low latency packets; or Quality Of Service (QoS) requirements of the low latency packets, wherein the AP includes one of a source AP or the selected target AP; and transmit a first reconfiguration response message to the non-AP STA, based on the received first reconfiguration request message, to manage low-latency communication in the communication network, wherein the first reconfiguration response message comprises a Down Link (DL) drain time of the selected target AP, wherein the DL drain time is set based on QoS requirements indicated in the first reconfiguration request message.

The language used in the disclosure has been selected for readability and instructional purposes, and it may not have been selected to delineate or circumscribe the disclosed subject matter. Accordingly, the disclosure is intended to be illustrative, but not limiting.

While various aspects and embodiments have been disclosed herein, other aspects and embodiments may be apparent to those skilled in the art. The various aspects and embodiments disclosed herein are for purposes of illustration and are not intended to be limiting, with the true scope and spirit including the following claims.

What is claimed is:

1. A method of managing low-latency communication in a communication network, the method comprising:
selecting, by a non-Access Point station (non-AP STA), a target Access Point (AP) from one or more candidate APs during a roaming procedure;
transmitting, by the non-AP STA, a first reconfiguration request message to the AP, during the roaming procedure, wherein the first reconfiguration request message comprises at least one of: a roaming phase type; an Identifier (ID) of the selected target AP indicating Media Access Control (MAC) address; or Quality of Service (QoS) characteristics of the non-AP STA comprising at least one of: a number of queued low latency packets; expiration time of the low latency packets; or Quality Of Service (QoS) requirements of the low latency packets, wherein the AP comprises one of a source AP or the selected target AP;
receiving, by the non-AP STA, a first reconfiguration response message from the AP, based on the transmitted first reconfiguration request message, wherein the first reconfiguration response message comprises at least a Down Link (DL) drain time of the selected target AP, wherein the DL drain time is set based on QoS requirements indicated in the first reconfiguration request message; and
managing, by the non-AP STA, the low-latency communication in the communication network, based on the received first reconfiguration response message.

2. The method of claim 1, wherein selecting the target AP from the one or more candidate APs during the roaming procedure, comprises:
identifying, by the non-AP STA, the one or more candidate APs configured to support low latency requirement for the non-AP STA, during a preparation phase of the roaming procedure;
transmitting, by the non-AP STA, a second reconfiguration request message based on the identified one or more candidate APs, to the source AP, wherein the second reconfiguration request message comprises at least one of the roaming phase type indicating the preparation phase, a presence indicator for the target AP identification, an Identifier (ID) of each of the one or more candidate APs indicating MAC address, and the QoS characteristics of the non-AP STA comprising at least one of number of queued low latency packets, expiration time of the low latency packets, and QoS requirements of the low latency packets;
receiving, by the non-AP STA, a second reconfiguration response message from the source AP, based on the transmitted second reconfiguration request message, wherein the second reconfiguration response message comprises at least one of a Low Latency Indication (LLI) status of the one or more candidate APs; and
selecting, by the non-AP STA, the target AP, from the one or more candidate APs, based on the received second reconfiguration response message.

3. The method of claim 2, wherein identifying the one or more candidate APs, comprises:
evaluating, by the non-AP STA, capability information of a set of nearby APs during a discovery phase of the roaming procedure; and
filtering, by the non-AP STA, the set of nearby APs, based on the evaluated capability information, to identify the one or more candidate APs.

4. The method of claim 2, wherein the LLI status in the second reconfiguration response message comprises at least one of complete acceptance, partial acceptance and/or rejection of the QoS requirements sent in reconfiguration request.

5. The method of claim 1, wherein the first reconfiguration request message is transmitted to the AP, and the first reconfiguration response message is received from the AP, during an execution phase of the roaming procedure.

6. The method of claim 1, wherein managing the low-latency communication in the communication network, comprises:
prioritizing, by the non-AP STA, uplink transmission of queued low-latency packets immediately after expiry of the DL drain time indicated in the first reconfiguration response message; and
managing the low-latency communication in the communication network, based on the prioritized uplink transmission.

7. A method of managing low-latency communication in a communication network, the method comprising:
receiving, by an Access Point (AP), a first reconfiguration request message from a non-Access Point station (non-AP STA), during an execution phase of the roaming procedure, wherein the first reconfiguration request message comprises at least one of: a roaming phase type indicating the execution phase; an Identifier (ID) of a selected target AP indicating a Media Access Control (MAC) address; or a Quality of Service (QoS) characteristics of the non-AP STA comprising at least one of: a number of queued low latency packets, expiration time of the low latency packets; or Quality Of Service (QoS) requirements of the low latency packets, wherein the AP includes one of a source AP or the selected target AP; and
transmitting, by the AP, a first reconfiguration response message to the non-AP STA, based on the received first reconfiguration request message, to manage low-latency communication in the communication network, wherein the first reconfiguration response message comprises a Down Link (DL) drain time of the selected target AP, wherein the DL drain time is set based on QoS requirements indicated in the first reconfiguration request message.

8. The method of claim 7, wherein transmitting the first reconfiguration response message to the non-AP STA, comprises:
determining, by the AP, completion of a context message transfer between the source AP, and the selected target AP, based on the first reconfiguration request message, wherein the context message comprises parameters related to the non-AP STA;
computing, by the AP, the DL drain time of the selected target AP, based on the determined completion;
generating, by the AP, the first reconfiguration response message, based on the computed DL time; and
transmitting, by the AP, the first reconfiguration response message to the non-AP STA.

9. The method of claim 8, wherein the context message comprises a negotiation request message including a Low Latency Indication (LLI) support flag.

10. A method of managing low-latency communication in a communication network, the method comprising:
transmitting, by an Access Point (AP), a negotiation request message to one or more candidate coordinated APs, wherein the AP is a coordinating AP, and wherein the negotiation request message comprises a Low Latency Indication (LLI) support flag;
receiving, by the AP, requirements related to QoS characteristics from the one or more candidate co-ordinated APs, based on the transmitted negotiation request message, wherein the QoS characteristics correspond to latency requirements of respective non-AP STA associated with each of the one or more candidate co-ordinated APs, and wherein the QoS characteristics comprises number of queued low latency packets, expiration time of the low latency packets, and Quality Of Service (QoS) requirements of the low latency packets including traffic flows and associated minimum and maximum service times; and
transmitting, by the AP, one or more allocation resources to each of the one or more candidate co-ordinated APs, based on the received requirements related to the QoS characteristics, for managing low-latency communication in a communication network.

11. The method of claim 10, wherein transmitting the one or more allocation resources to each of the one or more candidate APs, comprises:
prioritizing, by the AP, the one or more candidate co-ordinated APs, based on the QoS characteristics corresponding to each of the one or more candidate co-ordinated APs; and
transmitting, by the AP, the one or more allocation resources to each of the one or more candidate co-ordinated APs, based on the prioritization.

12. The method of claim 10, wherein the QoS characteristics are carried in Multi-Access Point Coordination (MAPC) Negotiation procedure in a MAPC element and in the Polling and Transmission Opportunity (TXOP) allocation phase in Initial Control Response frame.

13. A non-Access Point station (non-AP STA) for managing low-latency communication in a communication network, the non-AP STA comprises:
at least one processor comprising processing circuitry; and
a memory coupled with at least one processor, wherein at least one processor, individually or in any combination is configured to cause the non-AP STA to:
select a target Access Point (AP) from one or more candidate APs during a roaming procedure;
transmit a first reconfiguration request message to the AP, during the roaming procedure, wherein the first reconfiguration request message comprises at least one of: a roaming phase type; an Identifier (ID) of the selected target AP indicating Media Access Control (MAC) address; or a Quality of Service (QoS) characteristics of the non-AP STA comprising at least one of: a number of queued low latency packets; expiration time of the low latency packets; or Quality Of Service (QoS) requirements of the low latency packets, wherein the AP comprises one of a source AP or the selected target AP;
receive a first reconfiguration response message from the AP, based on the transmitted first reconfiguration request message, wherein the first reconfiguration response message comprises at least a Down Link (DL) drain time of the selected target AP, wherein the DL drain time is set based on QoS requirements indicated in the first reconfiguration request message; and
manage the low-latency communication in the communication network, based on the received first reconfiguration response message.

14. An Access Point (AP) for managing low-latency communication in a communication network, the AP comprises:
at least one processor comprising processing circuitry; and
a memory coupled with at least one processor, wherein at least one processor, individually or in any combination, is configured to cause the AP to:
receive a first reconfiguration request message from a non-Access Point station (non-AP STA), during an execution phase of the roaming procedure, wherein the first reconfiguration request message comprises at least one of: a roaming phase type indicating the execution phase; an Identifier (ID) of a selected target AP indicating a Media Access Control (MAC) address; or a Quality of Service (QoS) characteristics of the non-AP STA comprising at least one of: a number of queued low latency packets; expiration time of the low latency packets; or Quality Of Service (QoS) requirements of the low latency packets, wherein the AP includes one of a source AP or the selected target AP; and
transmit a first reconfiguration response message to the non-AP STA, based on the received first reconfiguration request message, to manage low-latency communication in the communication network, wherein the first reconfiguration response message comprises a Down Link (DL) drain time of the selected target AP, wherein the DL drain time is set based on QoS requirements indicated in the first reconfiguration request message.
